(19) United States
(12) Patent Application Publication
(10) Pub. No.: US 2026/0133794 A1
(43) Pub. Date: May 14, 2026

(54) RULES ENGINE

(71) Applicant: Citizens Financial Group, Inc., Providence, RI (US)

(72) Inventors: Ashutosh TRIPATHI, Plano, TX (US); Ajay PUNIA, Peoria, AZ (US); Dhiraj RATTAN, Gilbert, AZ (US); Vinod YADAV, Scottsdale, AZ (US); Vishal BANSAL, Phoenix, AZ (US)

(21) Appl. No.: 19/076,649

(22) Filed: Mar. 11, 2025

Related U.S. Application Data
(60) Provisional application No. 63/720,447, filed on Nov. 14, 2024.

(51) Int. Cl. G06F 8/71; G06F 3/04847; G06F 8/41

(52) U.S. Cl. CPC G06F 8/71; G06F 3/04847; G06F 8/42

(57) ABSTRACT

The present disclosure provides a system for decoupling decision-making logic from software applications. The system includes a platform with a rules engine and a user interface engine, a rules database accessible by the rules engine, one or more user devices configured to access the platform via a user interface generated by the user interface engine, and one or more third-party computing systems including software applications configured to consume rules created by the rules engine. The rules engine is configured to receive input for creating or modifying rules via the user interface, store the created or modified rules in the rules database, package the rules for consumption by the software applications, and make the packaged rules available to the software applications without requiring redeployment of the software applications.

### CROSS-REFERENCE TO RELATED APPLICATION

This application claims the benefit of priority under 35 U.S.C. § 119(e) to prior U.S. Provisional Patent Application No. 63/720,447 filed Nov. 14, 2024, the contents of which is incorporated by reference herein to its entirety.

### TECHNICAL FIELD

The present disclosure relates generally to software architecture, and more particularly, to a rules engine structure and platform for decoupling decision-making logic from software applications.

### BACKGROUND

In conventional software systems, decision-making logic is implemented directly within the software application code. This tightly coupled architecture introduces significant technical inefficiencies when the decision-making logic must be modified. For example, each software application that relies on similar or overlapping decision-making logic must implement and maintain its own instance of the logic. As a result, changes to decision-making logic often require redundant development and rework efforts across multiple applications.

In addition, modifying embedded decision-making logic necessitates recoding, recompiling, and redeploying the software application. This process is time-consuming, requiring careful testing and validation to ensure changes do not introduce new errors or adversely affect the application's functionality. Often, redeployment also necessitates application downtime, leading to disrupted operations and loss of productivity.

Embedded decision-making logic also increases the cost and complexity of maintaining software applications up-to-date. Each update requires developer resources, extensive testing, and repeated deployment cycles, increasing operational costs and elongating time-to-market for updates. In addition, time-sensitive updates to decision-making logic—such as responding to new regulations, changing business rules, or evolving customer requirements—are also delayed due to the constraints of the redeployment process.

Further, embedded decision-making logic is typically application-specific, which limits its reusability. Changes to the logic for one application do not propagate to other applications, even if they use identical or similar logic. As organizations deploy multiple interconnected applications, maintaining consistent decision-making logic across a system and/or a network of applications becomes a complex and error-prone process.

Further still, embedding decision-making logic within software applications consumes excessive computing and developer resources. The need to continuously modify, test, and redeploy applications, for example, imposes significant overhead on development teams and operational infrastructure.

Existing systems fail to provide a mechanism for centralizing and decoupling decision-making logic from software applications. Without this decoupling, modifications to decision-making logic are constrained by the application lifecycle, preventing dynamic updates or on-the-fly adjustments. In addition, applications are unable to leverage shared decision-making logic, resulting in fragmented logic management and unnecessary duplication. Further still, absent such decoupling of decision-making logic from software applications subjects organizations to operational delays, increased development and maintenance costs, and heightened risk of introducing errors during software updates.

These (and other) deficiencies of existing software systems hinder operational efficiency, reduce system scalability, and create barriers to innovation. As a result, there exists a need for a new rules engine structure and platform that decouples decision-making logic from software applications, enabling external creation, modification, and management of the decision-making logic without requiring changes to the underlying software applications themselves. Such a solution would improve the operating efficiency of software applications and systems by eliminating the need for repeated deployment cycles, enabling real-time updates to decision-making logic for time-sensitive use cases, allowing decision-making logic to be shared and reused across multiple applications, reducing development effort and improving consistency, and streamlining the management and maintenance of decision-making logic, reducing costs and resource consumption.

### SUMMARY

According to an aspect of the present disclosure, a system for decoupling decision-making logic from software applications is provided. The system includes a platform including a rules engine and a user interface engine, a rules database accessible by the rules engine, one or more user devices configured to access the platform via a user interface generated by the user interface engine, and one or more third-party computing systems including software applications configured to consume rules created by the rules engine. The rules engine is configured to receive, via the user interface, input for creating or modifying rules, store the created or modified rules in the rules database, package the rules for consumption by the software applications, and make the packaged rules available to the software applications without requiring redeployment of the software applications.

According to other aspects of the present disclosure, the system may include one or more of the following features. The rules engine may be further configured to receive, via the user interface, input for creating or modifying variables used in the rules, store the created or modified variables in the rules database, and make the variables available for use in creating or modifying rules. The variables may include at least one of: input variables, output variables, parameters, constants, derived variables, or real-time variables. The user interface may include selectors for defining logical groupings of the rules, the selectors including at least one of: a domain selector, an application selector, a sub-application selector, a ruleset selector, or a version selector. The user interface may include controls for managing the rules, the controls including at least one of: an add new rule button, an add variable button, a live deployment button, a version save button, a ruleset test button, or a spreadsheet download button. The rules engine may be further configured to validate syntax and variables of created or modified rules, and display validation results via the user interface. The rules engine may be further configured to receive, via the user interface, input for creating or modifying strategies comprising multiple rules, and store the created or modified strategies in the rules database. The rules engine may be further configured to convert packaged rules into executable classes compatible with runtime environments of the software applications. The user interface may include functionality for bulk uploading of rules or variables via a spreadsheet file. The rules engine may be further configured to generate forward-collection velocity variables for use in rules without requiring coding or compiling.

According to another aspect of the present disclosure, a method for decoupling decision-making logic from software applications is provided. The method includes receiving, via a user interface, input for creating or modifying rules, storing the created or modified rules in a rules database, packaging the rules for consumption by software applications, and making the packaged rules available to the software applications without requiring redeployment of the software applications.

According to other aspects of the present disclosure, the method may include one or more of the following steps. The method may include receiving, via the user interface, input for creating or modifying variables used in the rules, storing the created or modified variables in the rules database, and making the variables available for use in creating or modifying rules. The method may further include providing, via the user interface, selectors for defining logical groupings of rules, the selectors including at least one of: a domain selector, an application selector, a sub-application selector, a ruleset selector, or a version selector. The method may further include validating syntax and variables of created or modified rules, and displaying validation results via the user interface. The method may further include receiving, via the user interface, input for creating or modifying strategies comprising multiple rules, and storing the created or modified strategies in the rules database. The method may further include converting packaged rules into executable classes compatible with runtime environments of the software applications. The method may further include providing, via the user interface, functionality for bulk uploading of rules or variables via a spreadsheet file. The method may further include generating forward-collection velocity variables for use in rules without requiring coding or compiling.

According to another aspect of the present disclosure, a non-transitory computer-readable medium storing instructions is provided. When executed by one or more processors, the instructions cause the one or more processors to perform operations including receiving, via a user interface, input for creating or modifying rules, storing the created or modified rules in a rules database, packaging the rules for consumption by software applications, and making the packaged rules available to the software applications without requiring redeployment of the software applications.

According to other aspects of the present disclosure, the operations performed by the non-transitory computer-readable medium may include one or more of the following operations. The operations may include receiving, via the user interface, input for creating or modifying variables used in the rules, storing the created or modified variables in the rules database, making the variables available for use in creating or modifying rules, validating syntax and variables of created or modified rules, displaying validation results via the user interface, and converting packaged rules into executable classes compatible with runtime environments of the software applications. The operations may further include providing, via the user interface, selectors for defining logical groupings of the rules, the selectors including at least one of: a domain selector, an application selector, a sub-application selector, a ruleset selector, or a version selector.

The operations may further include providing, via the user interface, controls for managing the rules, the controls including at least one of: an add new rule button, an add variable button, a live deployment button, a version save button, a ruleset test button, or a spreadsheet download button. The operations may further include receiving, via the user interface, input for creating or modifying strategies comprising multiple rules, and storing the created or modified strategies in the rules database. The operations may further include providing, via the user interface, functionality for bulk uploading of rules or variables via a spreadsheet file. The operations may further include generating forward-collection velocity variables for use in rules without requiring coding or compiling.

### BRIEF DESCRIPTION OF DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 illustrates a block diagram of a rules engine system, according to aspects of the present disclosure;

FIG. 2A illustrates a flowchart for an onboarding process, according to an embodiment;

FIG. 2B illustrates a flowchart for variable logic operations, in accordance with example embodiments;

FIG. 2C illustrates a flowchart for rules operations, according to aspects of the present disclosure;

FIG. 2D illustrates a flowchart of executor operations, according to an embodiment;

FIG. 3 illustrates a flowchart for configuring software applications to consume packaged rules, according to aspects of the present disclosure;

FIG. 4 illustrates an exemplary user interface screen configured for defining logical groupings for rulesets, according to aspects of the present disclosure;

FIG. 5 illustrates an exemplary user interface screen that includes features and controls for creating, modifying, and managing rules and rulesets, according to aspects of the present disclosure;

FIG. 6 illustrates an exemplary user interface screen displaying a ruleset that has been transitioned into a read-only state, according to aspects of the present disclosure;

FIG. 7 illustrates an exemplary user interface screen configured for defining a new ruleset, according to aspects of the present disclosure;

FIG. 8 illustrates an exemplary user interface screen configured features and controls, including for adding new rules to a ruleset, according to aspects of the present disclosure;

FIG. 9 illustrates an exemplary user interface screen configured for adding, modifying, and managing variables, according to aspects of the present disclosure; and

FIG. 10 illustrates an exemplary user interface screen configured for defining new rules, according to aspects of the present disclosure.

To facilitate understanding, identical reference numerals may have been used, where possible, to designate identical elements that are common to the figures. It is contemplated that elements disclosed in one embodiment may be beneficially utilized on other embodiments without specific recitation.

### DETAILED DESCRIPTION

Software applications frequently rely on decision-making logic, comprising variables, conditions, instructions, etc., to govern workflows, automate processes, and perform operations. Traditionally, this logic is embedded within the software application itself, intertwining it with the application's core codebase. This disclosure relates to a new system and corresponding methods and computer program products for decoupling decision-making logic from the software applications that utilize it, thereby providing a more efficient and versatile rules engine structure and platform.

As discussed herein, decoupling decision-making logic from software applications allows for variables, conditions, instructions, and other aspects of the decision-making logic to be modified dynamically, without requiring re-deployment (e.g., re-coding or re-compiling) of the software applications. As a result, users can create, modify, manage, and maintain decision-making logic independently of the software applications that rely on it, while still ensuring seamless accessibility to the decision-making logic.

By eliminating the need to re-deploy software applications to implement changes, the approach and structure described herein improves system operational efficiency, reduces downtime, and accelerates updates. Furthermore, decoupling decision-making logic facilitates its sharing and reuse across multiple software applications, including concurrent usage, enabling centralized management and consistent application of logic. This capability is particularly beneficial for time-sensitive updates and scenarios where multiple applications can leverage shared or similar logic, enhancing both system efficiency and flexibility. In addition, this ability promotes consistency across software applications and reduces redundant development efforts. The centralized management of rules as described herein can also streamline maintenance processes and reduce associated costs.

As further described below, the rules engine technology described herein enhances flexibility, scalability, and efficiency in the management of software applications' decision-making logic. Among other things, this technology introduces a novel rules engine that is designed to efficiently handle intricate rules/rule sets, enabling automation of decision-making processes and enhancing workflows across various industries and implementations. It is a lightweight yet powerful tool that does not rely on heavy expression libraries, offering scalability, flexibility, and improved system performance.

In addition, the rules engine supports a wide range of rule types, including conditional rules, logical operators, mathematical expressions, and user-defined functions, allowing for versatile rule definition. Built on optimized algorithms, the rules engine ensures swift and reliable execution of rule sets without requiring extensive computational resources. Its scalable architecture accommodates growing data volumes and evolving use-case requirements, while its ability to process real-time data streams enables rapid decision-making based on up-to-date information. The platform's customization capabilities allow users to tailor decision-making logic to meet specific use-case needs, while seamless integration with existing systems ensures efficient deployment and adoption.

One key feature of the rules engine is its dynamic velocity variable creation, which enables real-time identification of patterns such as ring attacks or bot attacks without requiring application code changes. For example, this feature can capture the frequency of attributes or attribute combinations in real time and provide metrics such as dynamic counts over time intervals to support fraud detection strategies. For instance, the rules engine can identify multiple instances of the same phone number and social security number combination submitted across applications and flag those surpassing a predetermined threshold, such as 10 instances within two days, for example. This functionality enhances decision-making processes by providing actionable insights on the fly in several ways. It can allow for immediate detection and flagging of suspicious patterns as they emerge, without waiting for batch processing. The real-time nature of the insights may enable rapid response to potential fraud attempts. Additionally, the dynamic creation of velocity variables can adapt to new patterns or attack vectors without requiring manual updates to the rule set. This flexibility may improve the system's ability to detect novel fraud schemes. The rules engine can also correlate data across multiple applications or channels in real-time, potentially uncovering coordinated fraud attempts that may not be apparent when examining each application in isolation. Furthermore, this feature can be configured to provide other metrics (e.g., sum, average, mean, etc.) for attributed accumulation, allowing for a more comprehensive analysis of patterns and trends that can inform decision-making.

The rules engine of the present disclosure also requires no prior data setup, significantly reducing execution time compared to other tools. It can leverage in-house libraries for interpretation, eliminating the need for external dependencies, and supports distributed plug-and-play capabilities across various platforms and applications. In some cases, this capability may allow the rules engine to be quickly set up and integrated with different software systems, such as core deposit systems, ACH processing systems, or in-clearing deposit systems. Integration with machine learning models further enhances the rule engine's adaptability by enabling continuous learning and strategy improvement.

By decoupling decision-making logic from software applications, the rules engine streamlines workflows, enhances operational efficiency, and improves accuracy by eliminating coding and compilation errors. Additionally, the rules engine enables users to customize and modify decision-making logic for use by any number or type of software applications. This flexibility enables users to establish and implement strategies, and adjust those strategies dynamically as needed. To that end, the rules engine can be configured to include a dedicated library of terms and commands to interpret and execute user-defined strategies efficiently.

The rules engine can be set up quickly due to its distributed plug-and-play capabilities, which may allow it to integrate seamlessly with various platforms and software applications. This plug-and-play functionality may involve standardized interfaces and protocols that enable the rules engine to connect and communicate with different systems without extensive configuration. For example, the rules engine may utilize APIs or microservices architecture to facilitate easy integration. It may also include built-in adapters or connectors for common platforms and applications, such as core deposit systems, ACH processing systems, in-clearing deposit systems, etc.). Additionally, the plug-and-play capability may allow for dynamic discovery and configuration of connected systems, enabling the rules engine to automatically detect and adapt to the specific environment it is deployed in. This flexibility and ease of integration contributes to reduced setup time and improved compatibility across diverse IT ecosystems.

In some embodiments, the rules engine can be embedded directly into platforms and systems during production, bypassing the need for further development or user acceptance testing (UAT) while maintaining operational guardrails. In addition, embedding during production allows for immediate integration of rule-based decision-making capabilities.

Additionally, the rules engine can generate forward-collection velocity variables alongside offline roll-ups without requiring coding or compiling software. Forward-collection velocity variables may track the frequency or rate of certain events or attributes over time. For example, a forward-collection velocity variable could track the number of log-in attempts for a user account over the past 24 hours. These variables may be created dynamically as needed, without modifying the underlying application code. The rules engine can also include built-in validation tools for strategy development to help users when creating rules and strategies. For example, the rules engine can be configured with a syntax-checking module configured to automatically detect and flag syntax errors in rule definitions. In another example, the rules engine can include data type validation capabilities that ensure variables are being used appropriately based on their defined data types. These validation tools can help ensure efficient, error-free processes when developing and modifying rules and strategies.

Overall, the rules engine structure and platform described herein enhances operational efficiency, reduces system downtime, and provides greater adaptability in software applications that rely on decision-making logic. These improvements may be particularly beneficial in dynamic business environments where rapid adjustments to decision-making processes are frequently required.

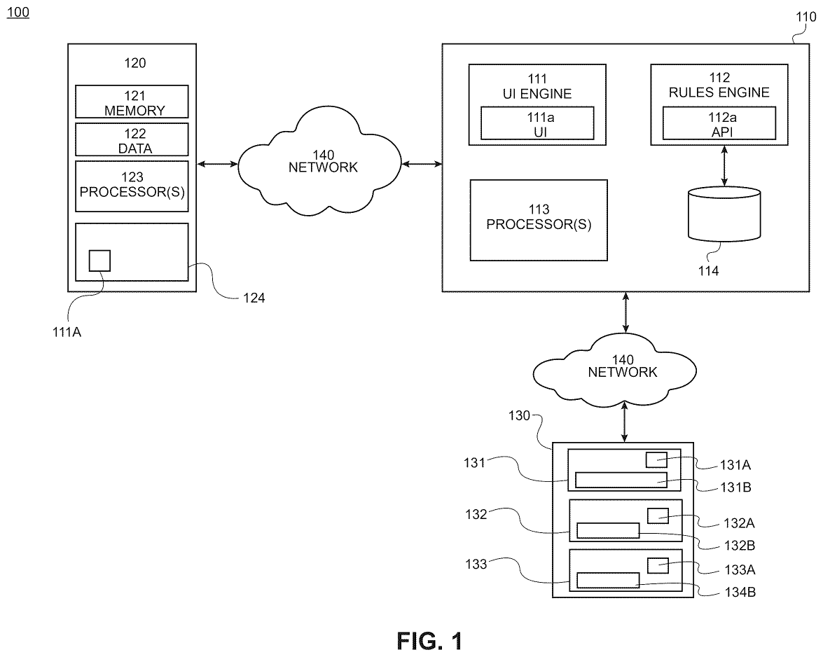

Turning now to FIG. 1, an exemplary rules engine system 100 according to the present disclosure is shown. The exemplary system 100 includes, among other things, a platform 110, one or more user devices 120, and one or more third-party computing systems 130. Each of the platform 110, the one or more user devices 120 and the one or more third-party computing systems 130 may be operatively connected to, and interconnected across, one or more communications networks 140. Examples of communications networks 140 may include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet, Bluetooth™, low-energy Bluetooth™ (BLE), ZigBee™, ambient backscatter communication (ABC) protocols, and so on. In some embodiments, communications between or amongst the platform 110, the one or more user devices 120 and/or the one or more third-party computing systems 130 may be encrypted and/or secured by establishing and maintaining one or more secure channels of communication across communications network(s) 140, such as, but not limited to, a transport layer security (TLS) channel, a secure socket layer (SSL) channel, or any other suitable secure communication channel.

The one or more user devices 120 may each comprise one or more tangible, non-transitory memory 121 that stores software instructions and/or data 122, and one or more processors 123 configured to execute the software instructions. The one or more tangible, non-transitory memory 121 may, in some examples, store application programs, application engines or modules, and other elements of code executable by the one or more processors 123. In an embodiment, the one or more user devices 120 may store within the one or more tangible, non-transitory memory 121, an executable application, which may be provisioned to any of the one or more user devices 120. The executable application may, when executed, provide the one or more user devices 120 with access to one or more applications, services, and/or resources of the platform 110.

In some embodiments, an executable application 122 stored on the one or more user devices 120 may be supported by the platform 110. Upon execution by the one or more processors 123, the executable application 122 may provide the one or more user devices 120 with access to one or more applications, services, and/or resources of the platform 110. This may include, among other things, displaying an interactive user interface (UI) 111a screen on a display unit 124 of the one or more user devices 120, establishing communications between the platform 110 and the one or more user devices 120, transmitting user data or other data and information from or to the platform 110 and/or to other systems or devices (e.g., third-party computing systems 130), etc.

As indicated above, each of the one or more user devices 120 may include a display unit 124 configured to present interface elements to a corresponding user, and an input unit configured to receive input from the corresponding user (e.g., in response to the interface elements presented through the user device's display unit 124). In some examples, a user device's display unit 124 may include, but is not limited to, an LCD display unit, a thin-film transistor (TFT) display, organic light emitting diode (OLED) display, a touch-screen display, or other type of display unit, and a user device's input unit may include, for example, a keypad, keyboard, touchscreen, fingerprint scanner, voice activated control technologies, biometric reader, camera, or another type of input unit.

In some embodiments, the functionalities of the display unit 124 and input unit may be combined into a single device, such as a pressure-sensitive touchscreen display unit 124 that presents interface elements and receives input from a user. In some embodiments, at least one among the one or more user devices 120 may include an embedded computing device (e.g., in communication with a smart textile or electronic fabric), or any other type of computing device that may be configured to store data and software instructions, execute software instructions to perform operations, and/or display information on an interface device or unit.

The one or more user devices 120 may also include a communications interface, such as a wireless transceiver device, coupled to one or more processors 123 and configured to establish and maintain communications with communications network 140 via one or more communication protocols, such as WiFi®, Bluetooth®, NFC, a cellular communications protocol (e.g., LTE®, CDMA®, GSM®, etc.), or any other communications protocol. In some embodiments, the one or more user devices 120 may also establish communications with one or more additional computing systems (e.g., third-party computing systems 130) or devices (e.g., others among the one or more user devices 120) operating within the system 100 across a wired or wireless communications channel, such as communications network 140 (e.g., via a communications interface using any appropriate communications protocol).

In some examples, at least one among the one or more user devices 120 may be associated with or operable by a user. Examples of the one or more user devices 120 may include, but are not limited to, any combination of mobile phones, smart phones, tablet computers, laptop computers, desktop computers, server computers, personal digital assistants, portable navigation devices, mobile phones, smart phones, wearable computing devices (e.g., smart watches, wearable activity monitors, wearable smart jewelry, glasses and other optical devices that include optical head-mounted displays (OHMDs)), embedded computing devices (e.g., in communication with a smart textile or electronic fabric), or any other computing device configured to capture, receive, store and/or disseminate any suitable data.

The exemplary platform 110 includes a combination of hardware and software components such as one or more servers and one or more tangible, non-transitory memory devices storing executable code, software modules, applications, engines, routines, algorithms, etc. Each of the one or more servers may include one or more processors 113, which may be configured to execute portions of the stored code, software modules, applications, engines, routines, etc. to perform operations consistent with those described herein. As will be described herein, the platform 110 embodies a unique rules engine structure that is configured to enable users and/or systems to create, modify, customize, and/or store rule sets that can be packaged for consumption by one or more software applications 131, 132, 133, all without having to recode, recompile, or otherwise redeploy the one or more software applications 131, 132, 133.

The executable code, software modules, applications, engines, routines, algorithms, etc. utilized by the platform 110 and described herein may comprise collections of code or computer-readable instructions stored on a media (e.g., in memory of the platform 110) that represent a series of machine instructions (e.g., program code) that implements one or more steps, features and/or operations. Such machine instructions may be the actual computer code that the processor(s) (not shown) of the platform 110 interpret to implement the instructions or, alternatively, may be a higher level of coding of the instructions that is interpreted to obtain the actual computer code. The software modules, engines, routines, algorithms, etc. may also include one or more hardware components. One or more aspects of an example module, engine, routine, algorithm, etc. may be performed by the hardware components (e.g., circuitry) itself, rather as a result of the instructions.

Although the platform 110 of FIG. 1 is shown as comprising a discrete computing system, it should be understood that platform 110 may correspond to a distributed computing system having multiple computing components distributed across one or more computing networks, such as communications networks 140 of FIG. 1, and/or those established and maintained by one or more cloud-based providers. Further, platform 110 may include one or more communications interfaces (not shown), such as one or more wireless transceivers, coupled to one or more processors 113 for accommodating wired or wireless internet communication across the one or more communications networks 140 with other computing systems and devices (e.g., user device(s) 120, third-party computing system(s) 130, etc.) operating within a computing environment.

As described herein, platform 110 may be configured to perform any of the exemplary functions and/or processes described herein to, among other things, enable users and/or systems to create, modify, customize, and/or store rule sets that can be packaged for consumption by one or more software applications 131-133, all without having to recode, recompile, or otherwise redeploy the one or more software applications 131-133. In this regard, the platform 110 may generate and make available an adaptive and interactive UI 111a described herein, which is capable of receiving input in real-time, and simultaneously from multiple users/user devices 120 and sources (e.g., third-party computing systems 130), as well as intelligently presenting features and functions of the platform 110 in a user-specific manner. In some embodiments, the interactive UI 111a may comprise an interactive UI browser, and in other embodiments, the interactive UI 111a may comprise an interactive graphical user interface (GUI).

Additionally, the platform 110 may be configured to receive, generate and/or compile information or data associated with one or more users. Examples of such data and information may include, for example, profile data, interaction data and any other type of data generated or captured by the platform 110, the user device(s) 120, the third-party computing system(s) 130 or any other source (collectively, “user data”). Profile data may include (without limit), a user's name, account information, security information or credentials (e.g., pin number, log-in credentials, etc.), user preferences (e.g., as to interface layout, output, function configurations, etc.), etc.

Interaction data may include data and information pertaining to users' interactions with the platform 110, such as requests, selections, queries, types of features and functions initiated, rule and rule set definitions, parameters and variables, type of data downloaded and/or uploaded, etc. Interaction data may be tracked in real-time as users (via user device(s) 120) are interacting with the platform 110, and it may include historical interaction data (e.g., captured during prior interaction sessions with any of the platform 110. In some embodiments, the interaction data may be captured via a monitoring module (now shown).

In order to store, maintain and access data and information, the platform 110 may include, within the one or more tangible, non-transitory memory devices, such as a data repository that includes one or more databases 114. The one or more databases 114 may be configured to store, maintain and provide access to the user data and information, as well as other types of data and information that may be generated and/or captured by the platform 110 and/or its components (e.g., rules, rule packages, APIs, etc., discuss further below).

The platform 110 may also include, within its one or more tangible, non-transitory memory devices, an applications repository that facilitates the performance of any of the exemplary processes and functions described herein. As illustrated in FIG. 1, the applications repository may include, among others, a UI engine 111 and a rules engine 112, each of which comprises computer-readable instructions that, when executed by one or more processors 113, enables each to generate, launch, execute and/or provide access to its respective applications, engines, modules, components, functions and/or operations.

The UI engine 111 may be configured to generate and dynamically update an interactive GUI and/or interactive UI browser (collectively, an interactive UI) 111a that may be rendered and/or displayed on the one or more user devices 120 and/or third-party computing system(s) 130. As will be appreciated, both the interactive UI browser and interactive GUI 111a provide an interactive and adaptive single point of access to all services, functions, resources, applications, data, etc. provided directly or indirectly by the platform 110. As a result, users may access the interactive UI 111a to create, modify and test rules, create and test variables and derivative variables that may be leveraged to create new rules, manage versions of rules and rule sets, bulk upload rules (e.g., created outside of the interactive UI 111a), and other features and functions relating to administering and managing rules and rule sets that may be consumed by the software applications 131-133.

In some embodiments, the platform 110 may provide access to a downloadable software application configured to be downloaded onto one or more user devices 120, such that launching the software application enables the one or more user devices 120 to access the platform 110, and more particularly, the rules engine 112, and initiate features and functions discussed below as being available via the interactive UI 111a.

The rules engine 112 can be configured to facilitate the creation, modification, management, and maintenance of the decision-making logic (i.e., rules and rulesets) described herein. That is, the rules engine 112 can be configured to execute code that enables and/or provides various features, functions, operations, and/or processes described herein and relating creating, modifying, managing, maintaining, etc. rules/rulesets and strategies. This includes, without limitation, onboarding software applications, onboarding users, onboarding input variables, configuring sub-applications, creating variable logic for use in creating and/or modifying rules and/or strategies, packaging rules and/or strategies for consumption, converting the packages to executable classes, and so on, each of which is further discussed below.

The rules engine 112 may be configured to generate and/or store in one or more databases 114 one or more application program interfaces (APIs) 112a that enable communications between applications (e.g., software programs, modules, engines), services, resources, etc., including those within the platform 110 and those from external sources (e.g., user devices 120, third-party computing systems 130, etc.). For example, the APIs 112a may be used to enable the transmission of rules/rulesets (and modifications thereto) between the interactive UI 111a and the rules engine 112, and for interfacing with any of the software applications 131-133 stored on the third-party computing systems 130. In this manner, rules/rulesets generated or modified via the interactive UI 111a rendered on a user device 120 can be made available by the rules engine 112 for consumption by software applications 131-133 embodied on the third-party computing systems 130. In some embodiments, the platform 110 may be configured to refresh one or more request/response and/or event-driven APIs in real-time or near real-time, so as to provide seamless access to any of the applications, services and/or resources described herein.

The rules engine 112 can also include and/or access one or more databases 114 designated for storing any number of rules/rule sets (e.g., rules database(s)), such as workflow rules, sub-workflow rules, exception rules and/or other types of rules (e.g., for initiating automated actions, for queueing and/or sequencing rules, etc.) generated or accessed by the rules engine 112, which may in turn be accessed and consumed by the software applications 131-133 according to their respective configuration. The rules engine 112 may also be configured to convert rules/rule sets into a format that is compatible for running in a particular runtime environment. In some embodiments, this conversion process may involve several steps. First, the rules engine 112 may parse the rules/rule sets to extract their logical structure and components. Then, it can translate this logical structure into code or instructions that can be executed in the target runtime environment. For example, if the target environment is a Java Virtual Machine, the rules engine 112 may convert the rules into Java bytecode. The conversion process may also involve optimizing the rules for performance in the specific runtime environment, such as by pre-compiling certain components or structuring the data in memory-efficient ways. Additionally, the rules engine 112 may generate any necessary wrapper code or interfaces to allow the converted rules to interact properly with other components in the runtime environment. This conversion capability may allow rules created in a high-level, user-friendly format to be efficiently executed across different types of systems and platforms.

In some embodiments, metadata associated with rules/rulesets may be transported from the interactive UI 111a to the rules engine 112, stored in the one or more databases 114, converted for running on a same virtual machine as the software application(s) 131-133 that will call the rules/rulesets, called by the software application(s) 131-133 and consumed by the software application(s) 131-133. To do this, the interactive UI 111a may package the metadata into a format suitable for transmission, such as JSON. The packaged metadata may then be sent to the rules engine 112 via an API call. Upon receipt, the rules engine 112 may store the metadata in one or more databases 113 for persistence. Next, the rules engine 112 may convert the stored metadata into a format compatible with the runtime environment of the target software application(s) 131-133, such as Java bytecode if the applications run on a Java Virtual Machine. The converted rules may then be made available to the software application(s) 131-133, which can call and execute them as needed during runtime. This approach may allow rules created through the UI to be efficiently transported, stored, converted, and consumed by applications without requiring application code changes.

The one or more third-party computing systems 130 may include one or more servers (not shown) and one or more tangible, non-transitory memory devices (not shown) storing executable code, application engines, and/or application modules. Each of the one or more servers (of the third-party computing systems 130) may include one or more processors, which may be configured to execute portions of the stored code, application engines or modules, and/or application programs to perform and/or provide one or more software applications 131-133 that may access and consume one or more rules/rulesets, generated via the rules engine 112, over one or more communication networks 140. As shown, the one or more software applications 131-133 software applications 103 may be embodied on one or more third-party computing systems 130 that are networked and communicate with the platform 110 via one or more communication networks 140. However, the software applications 131-133 may also or alternatively be cloud-based and/or collocated (e.g., stored and/or executed on a same computing device, platform, network, etc.), including within the platform 110 and/or one or more of its components.

In order to store, maintain and access data and information, the one or more third-party computing systems 130 may include, within their respective one or more tangible, non-transitory memories, and a data repository that includes one or more databases and/or storage devices. The one or more third-party computing systems 130 may also include, within the one or more tangible, non-transitory memories, a respective applications repository to facilitate the provision and execution of one or more respective software applications 131-133.

Each of the one or more software applications 131-133 may be configured to call, store and/or consume any of the rules/rule sets generated by and/or stored in the rules engine 112, all without having to be re-deployed (e.g., recoded, recompiled, etc.). As further explained below and illustrated in FIG. 1, the rules/rule sets may be packaged (131a, 132a, 133a) separate from and accessible for consumption by each respective software application 131-133 according to each software application's respective workflow (131b, 132b, 133b). This separation of rulesets from the software applications 131-133 that consume the rulesets constitutes the de-coupling described herein. As a result of this de-coupling, changes made to any of the rules/rule sets (or to rules package(s) 131a, 132a, 133a, discuss further below) called by the software applications 131-133 can be implemented without having to redeploy the software applications 131-133, thereby improving speed and operational efficiency with which such changes can be implemented and executed.

Communications between and amongst the UI engine 111, the rules engine 112 and the software applications 131-133 may be facilitated by the APIs 112a, as noted above, using standard text-based data objects such as JSON (JavaScript object notation), for example.

Features, embodiments, illustrative examples, and other aspects of the present disclosure are described herein in the context of Java-based software applications and microservices. It should be noted, however, that the present disclosure is not limited thereto. To the contrary, the rules engine structure and other features and functions described herein may be adapted for use with other types of applications and services, such as those based in Python or other programming languages.

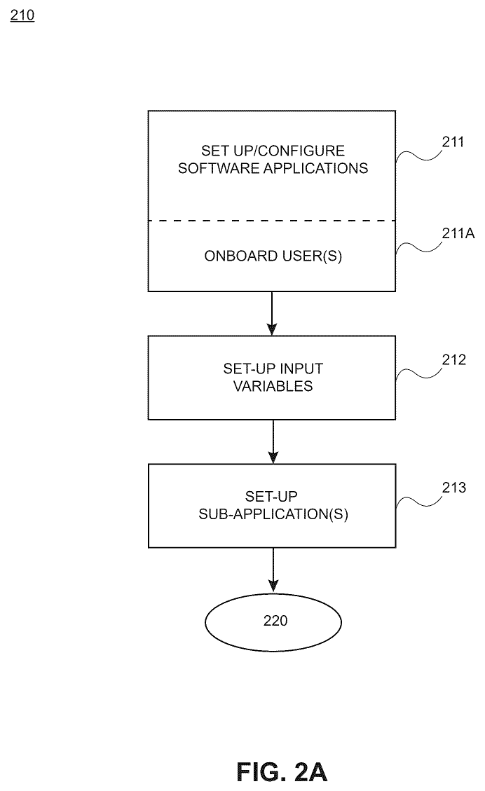

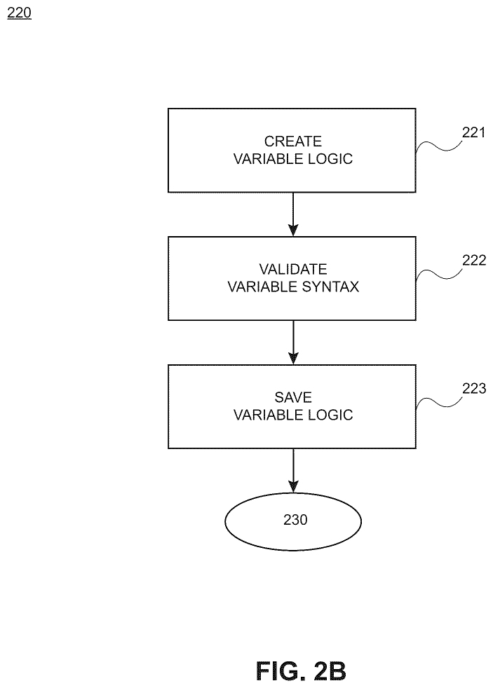

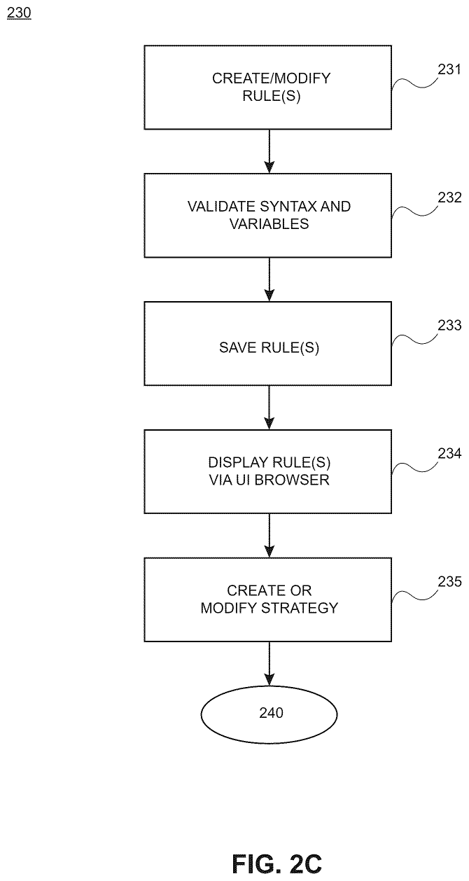

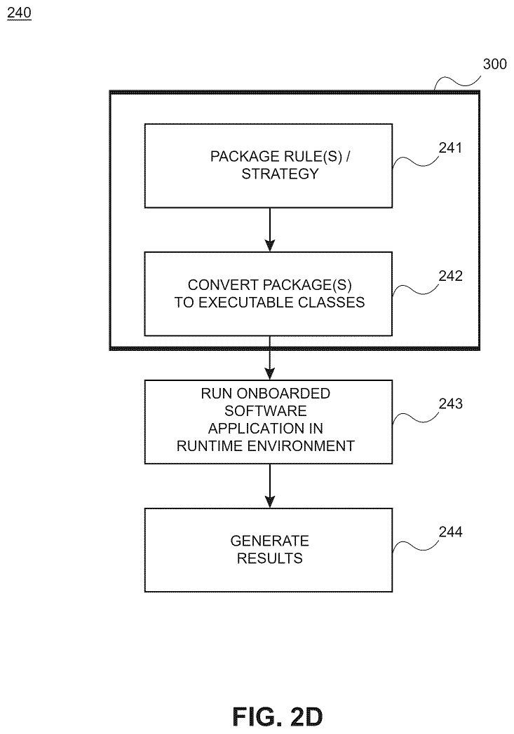

Referring now to FIGS. 2A-2D, exemplary process flow diagrams 210-240 illustrating certain operations of the exemplary rules engine structure depicted in FIG. 1 are shown. Notably, the operations illustrated throughout FIGS. 2A-2D and discussed below may themselves include one or more additional processes or sub-processes. It should also be noted that the operations and/or processes discussed herein are not limited to those shown in FIGS. 2A-2D. To the contrary, the rules engine structure embodied in the platform 110 of FIG. 1 and/or its components may be configured to execute an alternative combination of operations and/or processes (including one or more operations and/or processes that are not currently depicted) in accordance with the present disclosure. In addition, one or more of the operations and/or processes associated with and/or executed by the rules engine structure may be implemented or executed simultaneously and/or in any number of different sequences and/or by any number of systems and components (including by one or more components that are external to the platform 110 shown in FIG. 1).

FIG. 2A shows a first process flow diagram for Onboarding A Use Case 210 in accordance with the present disclosure. Onboarding A Use Case 210 may include categories of operations and processes associated with setting up and/or configuring (also referred to as “onboarding”) one or more software application 131-133 (step 211) to consume rules/rulesets, one or more users for managing rules/rulesets (step 211a), one or more variables (e.g., input variables) for defining one or more rules/rulesets (step 212), and one or more sub-applications (step 213). In some embodiments, Onboarding A Use Case 210 may include an alternative combination of operations and processes, including some that may be described further below. Collectively, the set(s) of operations and processes associated with Onboarding A Use Case 210 may broadly represent certain steps and functions associated with each of onboarding one or more software application 131, 132, 133 (step 211), onboarding one or more users (step 211a), onboarding input variable(s) (step 212) and configuring one or more sub applications (step 213).

Setting up or configuring a software application (step 211) may include establishing (e.g., during an initial onboarding process) or selecting (e.g., when modifying existing rules and/or strategies) logical groupings of strategies associated with the software application(s) 131-133. For purposes of this disclosure, a strategy refers to a selection or sequence of rules that when implemented, provides automated decision-making for one or more software applications 131-133. A rule broadly refers to a set of conditions (e.g., defined by one or more variables) under which certain actions of the software application are initiated. As an illustrative and non-limiting example, a rule may trigger a software application(s) 131-133 to generate an alert or notification if a user's savings account maintains a certain balance for a predetermined amount of time. As further discussed below, changes to this exemplary rule may be made without having to recode the software application(s) 131-133, thereby improving the efficiency and operation of both the application and the system on which it is being executed.

In some embodiments, as part of step 211, users may, via the interactive UI 111a, input or select one or more parameters (made available by the rules engine 112) for establishing or selecting the logical groupings for strategies associated with the software application(s) 131-133. Such parameters may include, for example, a domain (e.g., the particular software application(s) 131-133 that will call and consume rules created via the rules engine 112), type of software application, sub-application, a predefined rule set, a version of the predefined rule set, and/or one or more other parameters. As further discussed below, selecting a predefined rule set and/or a version of the predefined rule set may be applicable when modifying a logical grouping that has previously been established. During an initial onboarding process, however, users may leverage the rules engine 112 to define a first version of a first rule set in order to establish an initial logical grouping of strategies. Based on the selected parameters, available strategies that align with the selected logical groupings may be made available to the user (e.g., in cases where one or more strategies have already been established) and/or the user may leverage the rules engine 112 to build one or more strategies defined by the selected logical groupings.

In some embodiments, setting up or onboarding the software application (step 211) may also include onboarding one or users (step 211a), while in other embodiments, onboarding users (step 211a) may comprise its own, independent set of operations. Onboarding users (step 211a) may include establishing permissions that define the domains that each user may access, and the privileges associated with such access (e.g., editing, deleting, view-only, etc. of rules and/or strategies). This set of operations may also be facilitated via the interactive UI 111a generated by the UI engine 111.

Setting up or onboarding input variables (step 212) may also be a part of the Onboarding A Use Case 210 category of operations and processes. As noted above, variables may be used to define the rules (e.g., the conditions) under which one or more software application(s) 131-133 may initiate certain actions. Thus, before any rules are defined, variables that are currently utilized/defined by the software application(s) 131-133 (or that will be utilized by the software application(s) 131-133 in the future) may be onboarded to the platform 110. Setting up or onboarding the input variables (step 212) may involve uploading, via the interactive UI 111a, such variables. In some embodiments, one or more of the APIs 112a of the rules engine 112 may be configured to auto-identify such variables directly from the software application(s) 131-133, and import the variables directly to the rules engine 112. Notably, setting up or onboarding input variables (step 212) does not necessarily involve identifying and/or importing all of the variables associated with or defined by the software application(s) 131-133 being onboarded. Instead, a subset of all available input variables may be selected for onboarding at step 212 according to the rules or strategies that will be created and/or modified. In addition, derivative variables (e.g., variables derived from existing variables and/or variables that are yet-to-be defined by the software application(s) 131-133) may also be selected or defined at this point for use in rule/strategy making. As further discussed below, derivative variables can also be selected or defined while creating variable logic (see FIG. 2B, step 221).

Setting up one or more sub-applications (step 213) may include establishing or selecting one or more logical sub-groupings of rules to be associated with the software application(s) 131-133 that is being onboarded. This process may be similar to the process for establishing or selecting logical groupings as part of step 211.

Once the application(s), user(s), and input variable(s) are set up or onboarded (steps 211, 211a, 212, 213), operations and processes broadly referred to as Variable Logic Operations 220, as shown in FIG. 2B, may be initiated. This category of operations and processes may include creating variable logic for use in creating and/or modifying rules and/or strategies (step 221). Creating variable logic (step 221) may include, for example, selecting which of the onboarded variables (from step 212) will be used as input, output, etc. during the operations associated with the creation and/or modification of rules (see Rule Operations 230 in FIG. 2C, discussed below), selecting and/or defining parameters, defining derived variables (e.g., user-defined variables that are based on existing or to-be-defined variables, as discussed above), if any, etc. In some embodiments, the onboarded variables (from step 212) may be presented to users via interactive UI 111a as a selectable list, for example. The users may, in turn, select variables from such a list to create the variable logic, as discussed above.

To illustrate the concept of a derived variable, the following example is provided. If a software application includes a native AccountOpenDate variable, for example, a derivative variable may be defined as an AgeOfAccount variable. This derivative variable may be used to represent a length of time that a particular account has been open, and it may be defined as a determination that is made based on a current-day's date value and a value of the native AccountOpenDate variable.

Creating variable logic (step 221) may also include defining mapping functions and/or other types of functions involving existing and/or derived variables. Such mapping functions may allow users to transform or convert data from one format or structure to another. For example, a mapping function could be defined to convert a date string into a standardized date format, or to map categorical values to numerical codes. These mapping functions can be defined through the interactive UI 111a in some cases, enabling users to specify the input variable(s), the desired output format, and the logic for performing the transformation. The platform 110 may provide a graphical interface for visually constructing these mapping functions, or allow users to input custom code or formulas. Once defined, mapping functions can be saved and reused across multiple rules or strategies, potentially improving consistency, and reducing redundant logic. The ability to define custom mapping functions may enhance the flexibility of the rules engine 112, allowing it to handle a wider range of data transformations without requiring changes to the underlying software applications.

Once the variable logic is created (step 221), the rules engine 112 may initiate a validation routine to validate the variable logic syntax (step 222). This validation routine can involve parsing the variable logic to check for proper syntax and structure. It may then verify that all referenced variables exist and are of the correct data type. The validation routine can also include checking for logical consistency, ensuring that conditions are properly formed and that there are no contradictions or circular references. Additionally, it may involve validating any custom functions or formulas used within the variable logic. If any issues are detected, the validation routine may generate error messages or warnings to guide the user in correcting the problems. This validation process may help ensure the integrity and functionality of the variable logic before it is used in rule creation or modification.

The variables and variable logic (e.g., created in step 221) may then be saved (e.g., in a database 114) (step 223) for creating and/or modifying rules and/or strategies. Once saved (step 223), the variables and variable logic are ready for use in rule making and modification operations, broadly referred to as Rule Operations 230, as shown in FIG. 2C.

The Rule Operations 230 shown in FIG. 2C can include creating a new rule/rule set and/or modifying an existing rule/ruleset (step 231) via the interactive UI 111a, for example. Creating a new rule or ruleset (step 231) can include defining the conditions, using one or more variables and/or variable functions, under which certain actions of the software application(s) 131-133 may automatically be initiated. Modifying an existing rule or rule set (step 231) may include modifying the variables and/or variable logic included within an existing rule. In some embodiments, modifying a rule or rule set (step 231) may include cloning an existing rule, and modifying the cloned rule or strategy. In this manner, an existing rule or rule set may be preserved (e.g., as prior versions) while also making new version(s) of that rule or rule set available (e.g., for other use cases). In some embodiments, new rule(s) and/or modification(s) to existing rules can be uploaded to the rules engine 212 rather than creating or modifying them via the platform 110.

Once created or modified (step 231), the syntax and variables of the rules/rulesets can be validated (step 232) by initiating a validation routine, similar to the validation routine discussed above. Once validated (step 232) rules and rule sets may be stored and made available for use (step 233) in creating strategies, for example. A validated and saved rule/ruleset (step 233) may be displayed/made visible and selectable to users via the interactive UI 111a (step 234). Users may then select and order one or more rules, via the interactive UI 111a, to create a new strategy (step 235). As with rules, a strategy may be modified (step 235) by editing, re-ordering, adding, and/or removing one or more of the rules that define that strategy. In some embodiments, modifying a strategy (step 235) may include cloning an existing strategy, and then modifying the cloned strategy (e.g., as a new version) in order to preserve the existing strategy. Strategies and/or modifications thereto can also be updated from one or more external sources (e.g., spreadsheet), rather than generated and/or modified using the rules engine 112. For example, a modified strategy can be uploaded and used to replace a selected strategy.

In some embodiments, rules and/or strategies may be tested (e.g., using test data) prior to ‘going live’ (e.g., prior to making rules available for the Executor 240 category of operations and processes, discussed below). Such testing may occur in a test environment that is made available via the interactive UI 111a, for example.

As noted above, one or more of the operations and processes summarized above, including those broadly referred to as Onboarding A Use Case 210, Variables Logic Operations 220, and Rule Operations 230, can be initiated via the UI browser 111a.

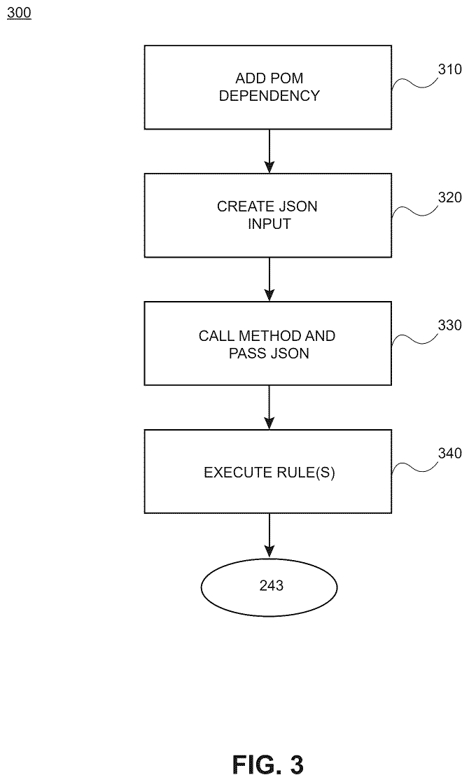

Turning now to FIG. 2D, operations and processes broadly referred to as Executor Operations 240 are shown. The Executor Operations 240 may include packaging rules and/or strategies (step 241), converting the packages to executable classes (step 242), running one or more onboarded software application(s) 131-133 (e.g., via FIG. 2A, step 211) in a runtime environment (step 243) and generating results according to a software application's 131-133 workflow and available data (step 244). In discussing aspects of the Executor Operations 240, reference will also be made to FIG. 3, which illustrates operations and processes relating to step 241 (e.g., packaging the rules and/or strategies that have been created and/or modified using the interactive UI 111a), and step 242 (e.g., converting the packages to executable classes, thereby making such packages available for consumption by the one or more software application(s) 131-133).

Turning now to FIGS. 3, a process 300 for configuring one or more software applications 131-133 to consume packaged rules and strategies is shown. This process 300 includes operations and processes relating to steps 241 and 242 of the Executor Operations 240, as noted above, which may be characterized as follows: Add POM Dependency (step 310); Create Json Input (step 320); 3) Call Method and Pass Json (step 330); and 4) Execute Rule(s) based on available data (step 340). The first step, Add POM Dependency (step 310), refers to operations associated with importing or packaging rules for consumption by a software application. This may include, for example, building a project object model (POM) that can be incorporated into a software application. In an embodiment, the POM may comprise an application file (e.g., an Extensible Markup Language (XML) file) having a string of code that facilitates one or more software application's 131-133 calling and consuming packaged rules 131a, 132a, 133a. In other embodiments, the software application(s) 131-133 may not use an automated dependency framework, and as a result, may not utilize a POM dependency. For example, a software application 131-133 can utilize a Java archive (JAR) file to package Java applications, libraries, or modules for distribution and deployment. Other embodiments can utilize other structures and/or types of application files for importing or packaging rules for consumption.

A second step, Creating Json Input (step 320), may include setting up a structure (in this example, a Json structure) within the one or more software applications 131-133 that identifies the rule or rulesets to be called/consumed by the software applications 131-133, and where to call them from. In an embodiment, the Json structure may comprise the following:

### Example Json Structure 1

{
“environment”: “P2”,
“application”: “CREDoposit”,
“domain”: “CRE”,
“subprocess”: [
{
“name”: “FRE”,
“rules”: [
{
“rule_name”: “FREConsumerNonTreasury”
}
}
}
}
}

As shown above, the Example Json Structure 1 may define a logical grouping using one or more parameters such as the environment, application, domain, subprocess, name, rule name, and/or other parameters that identify the ruleset(s) to be called. Then, when called, the logical grouping defined in the structure can return all ruleset(s) that satisfy that logical grouping. In some embodiments, various other Json structures can be created, each providing a different logical grouping configuration. In some aspects, this step 320 can further include converting the called ruleset(s) into executable classes (e.g., step 242). This conversion process can involve parsing the ruleset using a proprietary parsing component to extract its logical structure and components. The proprietary component does not utilize any external third-party language parser libraries. Instead, it comprises a custom Java-based component built to parse UI elements into executing classes. This proprietary parsing component leverages the application Java Virtual Machine (JVM) to run rules, which reduces dependencies on other infrastructure and memory usage. Additionally, the proprietary parsing component does not require any outbound calls during processing, as all rules are converted to native code along with the executor. This component then translates the logical structure into code or instructions that can be executed in the target runtime environment. For example, if the target environment is a Java Virtual Machine, the rules engine may convert the rules into Java bytecode. The conversion process may also involve optimizing the rules for performance in the specific runtime environment, such as by pre-compiling certain components or structuring the data in memory-efficient ways. Additionally, the rules engine may generate any necessary wrapper code or interfaces to allow the converted rules to interact properly with other components in the runtime environment. These executable classes could then be made available on the same virtual machine and as the application, ready for execution.

Once the structure of step 320 is created and set up, changes may be made to rules/rulesets (e.g., as discussed above with respect to FIG. 2C) independently of the software application(s) 131-133 that consume such rules/rule sets, without having to deploy the software application(s) 131-133, as discussed above. Indeed, since the structure is designed to return rulesets satisfying a defined logical grouping, rules may be added, re-ordered, changed, deleted, etc., and as long as the changed rules continue to satisfy the defined logical grouping, those rules will be returned.

The Call Method and Pass Jason (step 330) may include coding an actual call (or calls) for returning ruleset(s) that comply with the logical grouping of step 320. In an illustrative example, a coded call can comprise the following: “import com.XYZ.com.platform.util.GetRules;” or “GetRules.getRule(json.Object).”

Next, the Execute Rule(s) based on available data (step 340) can include configuring a workflow 131b, 132b, 133b of the one or more software application(s) 131-133 (e.g., with a Json configuration file), such that the ruleset(s) identified via step 320 can be called at precisely the right time within the software application's workflow(s) 131b, 132b, 133b. Thus, for example, if a software application 131-133 includes a workflow having five steps (e.g., steps 1, 2, 3, 4 and 5), and a ruleset package 131a, 132a, 133a is to be called after step 2, the workflow can be reconfigured to include a call to the ruleset package 131a, 132a, 133a directly after step 2. This reconfiguration process can involve modifying the application's control flow to insert API calls or function invocations at the appropriate points in the workflow. In some cases, this may be achieved through configuration files that define the workflow structure, allowing the insertion of rule execution steps without modifying the core application code. Alternatively, the software applications 131, 132, 133 may be designed with predefined extension points where rules can be dynamically injected at runtime. In an illustrative example, in a software application workflow 131b of a respective software application 131, a call to an application rules package 131a may be inserted after a transaction is initiated but before it is processed. This configuration may allow the application 131 to apply fraud detection rules to each transaction as it occurs.

Upon completion of this step 340, each of the software application(s) 131-133 is now configured for execution.

Returning now to FIG. 2D, once the software application 131-133 has been configured (or reconfigured), the Executor Operations 240 can include running the configured software application in a runtime environment (step 243) and generating results according to the software application's workflow and available data (step 244). In some embodiments, the runtime environment may include a virtual machine, such as a Java Virtual Machine, which allows programs coded in one language to run on different operating systems and platforms.

Notably, features and functions of the rules engine structure embodied in the platform 110 are described in the context of Java-based applications and microservices, however, the rules engine structure may be configured for use with other types of applications and microservices (e.g., Python, etc.).

The rules engine system 100 is configured to generate and display interactive user interface (UI) screens that provide an intuitive and interactive way for users to interact with the platform 110. These screens can be generated by the user interface engine 111 and can be accessed via the one or more user devices 120. The user interface screens serve as a means for users to create, modify, and manage rules and strategies within the rules engine system 100.

In some cases, the user interface engine 111 can generate an interactive UI 111a that comprises an interactive GUI and/or an interactive UI browser that display the various interactive UI screens. This dual interface approach allows for flexibility in how users interact with the system 100. The interactive GUI can be utilized to provide a more visual and intuitive way to work with rules and strategies, while the UI browser can offer more advanced functionality for power users.

The UI screens discussed below are designed to facilitate various operations within the rules engine system 100. These operations can include, but are not limited to, selecting parameters for viewing and managing rulesets, adding, and modifying rules, configuring variables, and managing rule execution. By providing a comprehensive set of interface elements, the UI screens enable users to effectively leverage the capabilities of the rules engine system 100 without requiring direct interaction with the underlying code or system architecture.

Through these UI screens, users may be able to perform complex tasks such as defining logical groupings for strategies, creating, and modifying rules, and managing different versions of rulesets. The UI screens can also provide functionality for bulk operations, allowing users to efficiently manage large numbers of rules or variables simultaneously.

In some cases, the UI screens can include validation features that help ensure the integrity of user-created rules and strategies. These features may provide real-time feedback to users, helping to prevent errors and improve the overall quality of the decision-making logic being developed.

The UI screens described herein play an important role in making the rules engine system 100 accessible and usable for a wide range of users, from business analysts to technical developers. By providing user-friendly interfaces to the complex functionality of the rules engine 112, these UI screens help to streamline the process of managing decision-making logic across multiple software applications (e.g., 131-133).

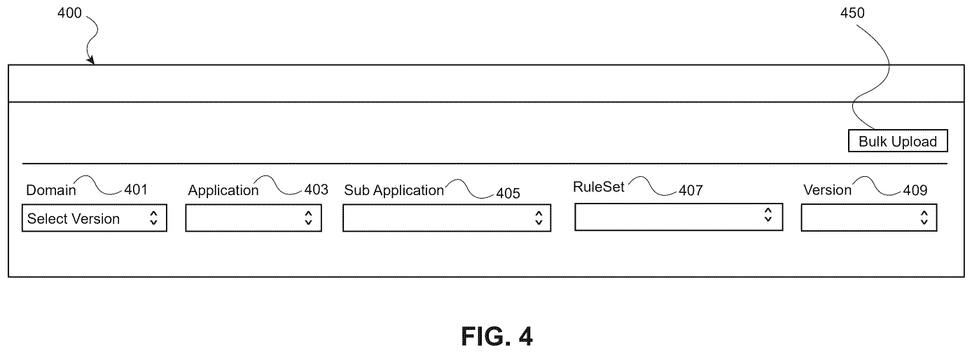

Turning now to FIG. 4, an exemplary UI screen 400 is shown with several parameter selector components 401-409 arranged horizontally across the top of the UI screen 400. As noted above, this UI screen 400 can be accessed and displayed via an interactive UI 111a displayed on a user device 120. In this example, the UI screen 400 includes parameter selectors 401-409 configured as dropdown menus, although the parameter selectors 401-409 can be configured as other types of data components in other embodiments. The parameter selectors 401-409 shown include a domain selector 401, an application selector 403, a sub application selector 405, a ruleset selector 407, and a version selector 409. These selectors 401-409 may be configured to enable users to navigate through different levels of rule organization, enabling efficient management of rulesets across various domains and applications. The parameter selectors 401-409 can be used for defining logical groupings, with the grouping of parameters being hierarchical. For example, selecting a particular domain option (e.g., via the domain selector 401) can limit selectable application options to those within the selected domain, and selecting a particular application option (e.g., via the application selector 403) can limit selectable sub-application options to those within the selected application, and so on. This hierarchical structure allows users to logically define strategies without affecting other existing strategies, and to create different logical groupings that impact the same application.

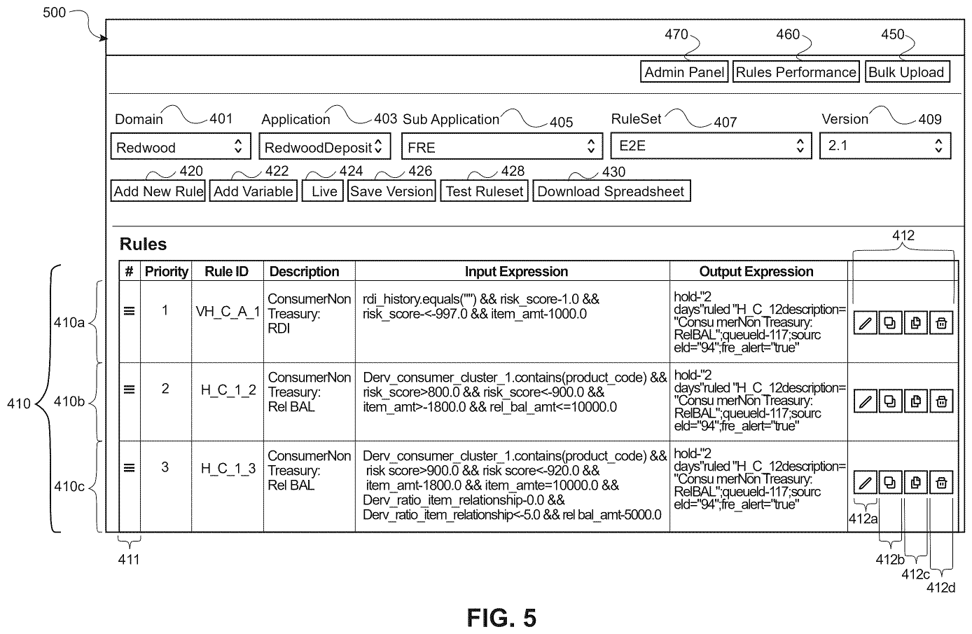

The domain selector 401 serves as a categorization mechanism, enabling users to filter and focus interactions within distinct sections or domains of a software application 131-133. The application selector 403 can be configured to present users with selectable applications available in the selected domain. The sub application selector 405 offers selectable options tailored to subdivisions within the selected application. The ruleset selector 407 allows users to choose specific rulesets associated with the selected domain, application, and sub-application. The version selector 409 enables users to select different versions of a ruleset, facilitating version control and historical tracking of rule changes. Once each of the domain, application, sub application, ruleset and version are selected, that is, once a logical grouping is defined, the list of rules associated with that logical grouping are displayed, as illustrated in FIG. 5, discussed below.

The exemplary UI screen 400 also includes a bulk upload button 450. This feature can be used for uploading entire rulesets in bulk using a spreadsheet format file, for example, thereby streamlining the process of importing multiple rules simultaneously. This feature is also discussed in further detail below with respect to FIG. 5.

FIG. 5 illustrates another exemplary UI screen 500 that expands upon the UI screen 400 shown in FIG. 4. As noted above, once a logical grouping is defined (e.g., by selecting a combination of domain, application, sub application, ruleset, and version), the list of rules 410a, 41b, 410c associated with that logical grouping can be displayed, as shown in UI screen 500. In this example, the exemplary UI screen 500 maintains the same parameter selectors 401-409 discussed above with respect to UI screen 400. This enables users to select different logical groupings and display different sets of rules. Below the parameter selectors 401-409, the exemplary UI screen 500 displays a ruleset 410 with multiple rules 410a, 410b, 410c according to the selected logical grouping. As shown, the multiple rules 410a, 410b, 410c are ordered according to their priority, that is, rule 410a which has a priority of 1 and is listed first, rule 410b which has a priority of 2 is listed second, and the third rule 410c has a priority of 3. Each rule 410a, 410b, 410c in the ruleset 410 includes a rule order indicator 411, which can be used for reordering the rules 410a, 410b, 410c. For example, users can reorder the rules 410a, 410b, 410c by dragging and dropping them using a respective rule order indicator 411, allowing for flexible arrangement of rule priorities.

The exemplary UI screen 500 also includes several rule-specific fields pertaining to each displayed rule 410a, 410b, 410c. These fields can include a rule priority field 414 (discussed above), a rule description field 416, a rule input expression field 418, and a rule output expression field 419. These fields provide detailed information about each rule 410a, 410b, 410c within the displayed ruleset 410. As will be appreciated, this display format allows users to quickly assess the structure and content of the rules 410a, 410b, 410c in the current ruleset 410.

At the end of each rule row, rule action buttons 412 are displayed, each configured for initiating one or more actions relating to the respective rules 410a, 410b, 410c. These buttons 412 include an edit button 412a, a clone button 412b, a copy button 412c, and a delete button 412d. The edit button 412a can be configured to enable users to modify a respective rule 410a, 410b, 410c (e.g., by modifying one or more rule-specific fields), providing the capability to add more inputs or outputs, adjust conditions, refine the rule's parameters, and the like. This functionality enables users to expand or refine a rule's criteria. The clone button 412b can be used to create a duplicate of a rule that can be edited, such as by adding more or alternative conditions or other modifications. A cloned rule will have a unique rule identifier so as to distinguish it from the rule from which it was cloned. The copy button 412c enables a user to create a copy of a rule's configuration for reuse in creating another (similarly-configured) rule. And as its name implies, the delete button 412d enables a user to remove a rule from a ruleset. Collectively, these buttons 412 enable users to modify, duplicate, or remove individual rules 410a, 410b, 410c within a ruleset 410.

The exemplary UI screen 500 also includes several control buttons, such as an add new rule button 420, an add variable button 422, a live deployment button 424, a version save button 426, a ruleset test button 428, and a spreadsheet download button 430. In other embodiments, additional, fewer or an alternative combination of control buttons can be provided. Each of the control buttons 420-430 provides specific functionalities for managing and manipulating the ruleset 410.

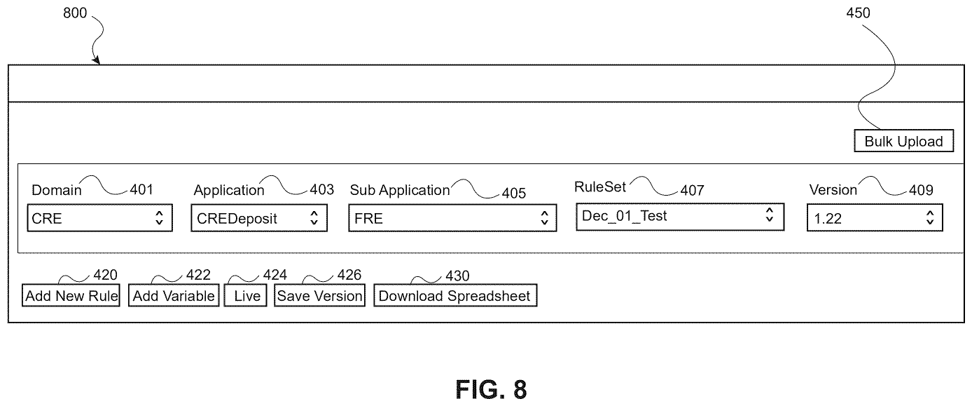

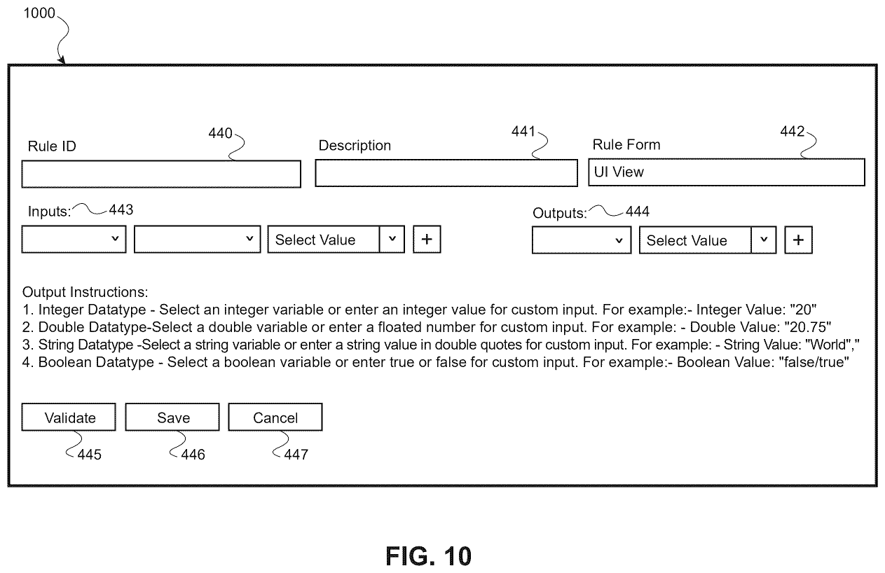

For example, the add new rule button 420 enables users to create new rules within the current ruleset 410. This feature is further discussed below in connection with FIG. 10. The add variable button 422 enables users to select and/or define new variables for use in creating rules. This feature is further discussed below in connection with FIGS. 8 and 10. The live deployment button 424 facilitates a process of making rules active in a production environment. Selecting the live deployment button 424 can initiate a process that includes sending a request to an administrative user. Such a request can be accessed, reviewed, and acted upon by an administrative user via the admin panel button 470 (discussed below), for example.

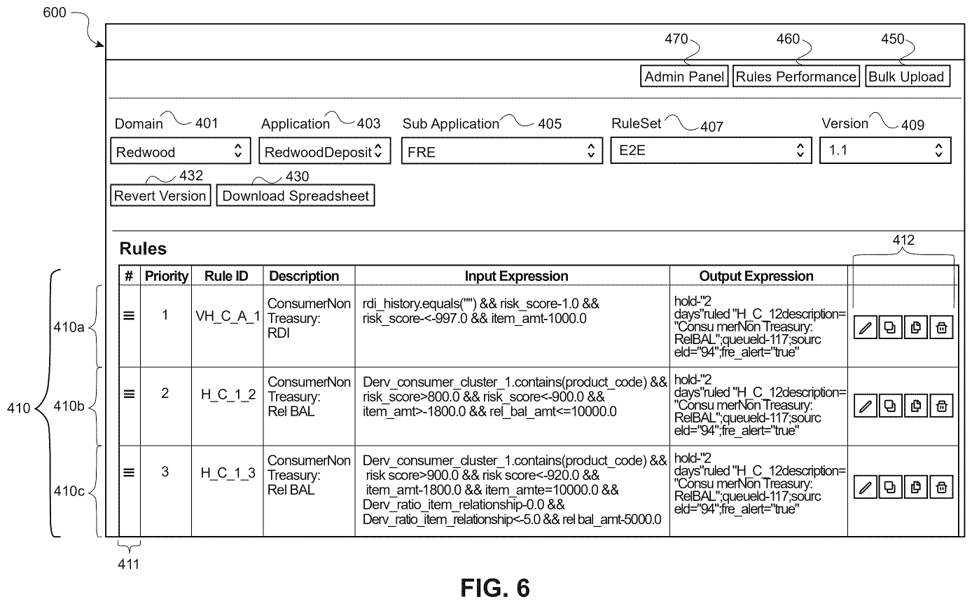

The version save button 426 enables users to create new versions of a ruleset 410, preserving previous versions for reference or rollback purposes. When selected, the version save button 426 can initiate a process for saving a current version of the ruleset 410 and transitioning that current version into a read-only state, thereby preserving its existing rules 410a, 410b, 410c without allowing further modifications. This is illustrated in FIG. 6, via UI screen 600, in which the version save button 426 has been initiated, thereby transitioning the current ruleset version 1.1 to a read-only state. Simultaneously, all the rules 410a, 410b, 410c associated with the current version (in this case, ‘1.1’) are transferred or duplicated into a next version, for example, ‘1.2’ (not shown). This action effectively moves all the existing rules 410a, 410b, 410c to the latest version (‘1.2’), enabling users to continue their work and make modifications or additions to the rules without affecting the previous ‘1.1’ version. This versioning and rule transfer process enables users to preserve and maintain a historical record of rules 410a, 410b, 410c under each version while allowing ongoing modification to the rules 410a, 410b, 410c in a newer version.

The ruleset test button 428 provides functionality for testing the current ruleset 410 before its live deployment. Any conflicts or errors identified during such testing can be identified and resolved prior to making the ruleset 410 live.

The spreadsheet download button 430 enables users to export ruleset data in a spreadsheet or other format for offline analysis or backup. Upon clicking this button 430, a file that includes a comprehensive compilation of the ruleset data, including ruleset elements, expressions, variables, inputs, outputs, parameters, constants, derived inputs, and other detailed information (including the rules themselves), can be generated and downloaded. In some embodiments, the file can include tables, charts, and other forms of data.

The exemplary UI screen 500 can also include a bulk upload button 450, a rules performance button 460, and/or an admin panel button 470. The bulk upload button 450 can be configured to enable users to import multiple rules or rulesets simultaneously (e.g., via a file), streamlining the process of rule creation for large or complex rule sets. Upon clicking this button 450, users can be prompted to select a file (e.g., a spreadsheet file) from their system or device 120, which includes detailed information about the rules they wish to upload. After selecting the desired file, a confirmation prompt can appear to obtain user validation to proceed with uploading the data from the file. Upon confirmation, the upload process can be initiated, integrating the rules and their associated details from the file into the application's database. Subsequently, these uploaded rules can be displayed within the UI screen 500, allowing users to access, manage, and work with the newly added rules/rulesets seamlessly.

The rules performance button 460 can be activated to reveal metrics and related data associated with the performance or usage of any given rule 410a, 410b, 410c or ruleset 410. For example, selecting this button 460 can display the number of times a particular rule was implicated or utilized during a particular period of time. This type of information can be utilized to determine the utilization and/or other performance metrics associated with rules.

The admin panel button 470 can provide access to administrative functions for managing access to rulesets and other system-wide settings. For example, selecting the admin panel button 470 can provide administrative users with access to an administrator portal (not shown) for managing any number of rules and rulesets, as well as requests associated therewith. This portal can provide administrative users with capabilities to oversee and control access to various rulesets and/or requests made by rule-making users. In some embodiments, the portal can be divided into several key modules, each providing a specific combination of functions for ensuring efficient and secure management of rulesets: 1) Live Ruleset module, 2) Unlock Ruleset module, 3) Revert Ruleset module, 4) User Onboard module, and 5) Application Variables module.

The Live Ruleset module can comprise features and functions configured to enable administrative users to approve requests for making rulesets live. When a rule-making user creates and/or modifies a ruleset, for example, the rule-making user can initiate a request for an administrative user to approve placing that ruleset into a live production environment via this module. This helps ensure that only verified and authorized rulesets are implemented, maintaining system integrity and security. Administrative users can review ruleset requests and approve or reject them, preventing unauthorized or potentially harmful rulesets from being activated.

The Unlock Ruleset module can comprise features and functions configured to facilitate the sharing of rulesets between users. If, for example, User X creates a ruleset that User Y wants to access, User Y can request access via this module (e.g., by clicking an ‘unlock’ button within this module). An administrative user can then review this request via this module and approve or deny access based on the requirements and the specific needs of the users involved. This module can provide controlled access to rulesets, ensuring that only authorized users can view and/or modify the rulesets, thus maintaining security and proper governance.

The Revert Ruleset module can be configured to handle requests for reverting rulesets to a previous version, as discussed above. If, for example, User Y determines that an older version of a ruleset is more appropriate or effective than a current version, User Y can request a revert to the older version by clicking a revert version button (further discussed below with reference to FIG. 6). An administrator user can then evaluate the request and approve or deny it using this module, ensuring that changes are made with oversight. This module provides a mechanism for maintaining the efficacy and appropriateness of rulesets, allowing users to return to earlier versions, when necessary, under the supervision of an administrative user.

The User Onboard module can be configured to simplify the process of adding new users to the system 100. Administrative users can onboard new users, granting them access to the platform 100 and assigning appropriate domain and roles. Additionally, if a user requires administrative privileges, this can also be facilitated through this module, ensuring that authorized users are granted an appropriate level of access. This module can also ensure that users are efficiently onboarded and have the appropriate access levels, promoting smooth operations and proper access control within the system 100.

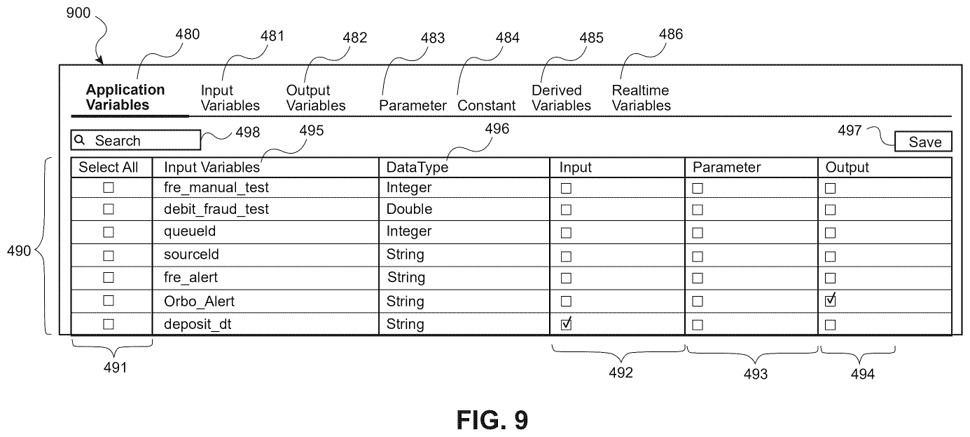

The Application Variables module can be configured to simplify the process of adding/modifying application variables to the system (discussed below with reference to FIGS. 8-9). Administrative users can onboard new and/or edit existing variables using this module. This module ensures that variables are efficiently onboarded and have the appropriate data for them within the system.

Turning now to FIG. 6, an exemplary UI screen 600 is shown displaying a ruleset in a read-only state. The UI screen 600 includes the logical grouping (parameter) selectors 401-409 discussed above with reference to UI screen 500, namely, the domain selector 401, application selector 403, sub application selector 405, ruleset selector 407, and version selector 409. UI screen 600 also displays the ruleset 410, its respective rules 410a, 410b, 410c and rule-specific fields (e.g., the rule order indicator 411, the rule priority field 415, the rule description field 416, the rule input expression field 418, and the rule output expression field 419) discussed above and shown in UI screen 500.

Unlike UI screen 500, however, this UI screen 600 is generated and displayed in a read-only state as a result of selecting the version save button 426 (displayed on UI screen 500). As previously discussed, selecting the version save button 426 (via UI screen 500) can initiate a process for saving a current version of the ruleset 410 and transitioning that current version into a read-only state, thereby preserving its existing rules without allowing further modifications. Because the ruleset 410 is in the read-only state, the rule action buttons 412 (including the edit button 412a, clone button 412b, copy button 412c, and delete button 412d) are disabled, as indicated by their greyed-out appearance. This prevents modifications to this version of the ruleset 410.

UI screen 600 also includes the spreadsheet download button 430, bulk upload button 450, a rules performance button 460 and an admin panel button 470, all of which are also displayed on UI screen 500 and discussed above. In addition, UI screen 600 includes a revert version button 432, which can be configured for returning to a prior version of the ruleset 410. When selected on this UI screen 600, the revert version button 432 can cause the current, read-only version of the ruleset 410 to revert to an active and editable state, such as shown on UI screen 500, which includes re-enabling the rule action buttons 412.

In some embodiments, authorization for initiating a revert version action must first be authorized (e.g., by an administrative user). In such embodiments, selecting the revert version button 432 could initiate an authorization process that includes sending a request to an administrative user, which can be accessed, viewed and acted upon by the administrative via a revert ruleset module available through the admin panel button 470.

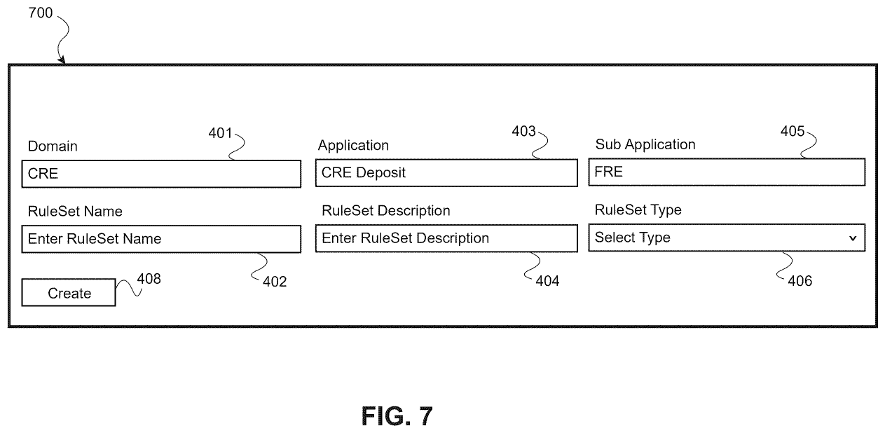

FIG. 7 illustrates a ruleset creation screen 700 for defining a new ruleset. The ruleset creation screen 700 includes several selector fields that identify the domain 401, application 403 and sub application 405. Each of these fields can be pre-populated and non-modifiable to maintain alignment with the selected domain, application, and sub application to which the new ruleset pertains. This ensures that new rulesets are created within the appropriate context.

Ruleset creation screen 700 also includes fields for entering information specific to the ruleset being created. A ruleset name field 402 allows users to input a unique identifier for the new ruleset. This unique identifier facilitates the new ruleset's identification and categorization. If an entered ruleset name matches an existing ruleset name, an alert message can be generated and displayed to promptly notify the user that the entered ruleset name already exists and to prompt the user to enter a different, unique ruleset name.

A ruleset description field 404 provides space for users to describe the purpose or details of the ruleset, thereby aiding in its comprehension and management.

A ruleset type field 406 enables users to specify the type of ruleset being created. In some embodiments, the ruleset types can include ‘one’ and ‘all.’ Selecting ruleset type ‘one,’ for example, can set a default rule for the new ruleset. When adding a new rule for the first time after selecting ‘one’ as the ruleset type, this feature can present only output fields, displaying the default rule. Under this type of ruleset, a user will be able to execute only one rule.

Selecting ‘all’ as a ruleset type, on the other hand, can enable users to add rules with both input and output fields to the new ruleset. There is no default rule when ‘all’ is selected, and rules added subsequently can automatically set the priority order, with the first rule being assigned as the first priority, followed by subsequent rules in incremental order. Under this type of ruleset, a user can execute one rule and all rules.

Once all data fields are entered in the ruleset creation screen 700, selecting the create button 408 can cause the rules engine 112 to receive the input for creating the new ruleset via the ruleset creation screen 700. The new ruleset can then be populated with new rules via, for example, a rule creation screen. The new ruleset can then be stored by rules engine 112 in a database 114.

In some embodiments, the ruleset creation screen 700 can also include the bulk upload button 450 for uploading ruleset information using a spreadsheet format file, for example. This feature can enable users to create entire rulesets (and multiple rules) efficiently, supporting the system's capability for bulk rule management, as discussed above.

New rules can be added to a newly created ruleset (or to an existing ruleset) by activating an “add new rule” feature via, for example, an add new rule button 420, as shown on an exemplary UI screen 800 of FIG. 8. Indeed, FIG. 8 shows a rule engine UI screen 800 that includes such an add new rule button 420, together with other operational buttons discussed above (see e.g., FIG. 5), namely, the add variable button 422, the live deployment button 424, a version save button 426, the spreadsheet download button 430, and the bulk upload button 450. The admin panel button 470 is also included on UI screen 800. Collectively, these buttons offer various functionalities for managing rules and variables within the system 100.

FIG. 9 illustrates another user interface (UI screen 900) that may be displayed when a user selects the add variable button 422 (e.g., as shown on UI screen 800 of FIG. 8). This UI screen 900 can comprise multiple tabs for organizing and interacting with different types of variables, including (without limitation): an application variables tab 480, an input variables tab 481, an output variables tab 482, a parameters tab 483, a constants tab 484, a derived variables tab 485, and a real-time variables tab 486. This tabbed structure allows users to efficiently manage various types of variables within the rules engine system 100. In some embodiments, the UI screen 900 can include more or fewer tabs relating to a different combination of variable types.

Selecting the application variables tab 480, as is shown on UI screen 900, can display a list of application variables 490 that have already been defined. These application variables 490 can be uploaded (e.g., via the bulk upload button 450 discussed above) and/or auto-identified (e.g., from a software application 131-133 being onboarded) by the platform 110. As shown, users can select which application variables 490 to make available for use in making rules, as well as the way in which the application variables 490 can be used, by selecting respective input checkboxes 492, parameter checkboxes 493, and/or output checkboxes 404. Selecting the select all checkbox 491 next to a particular application variable 490 can automatically select the input checkbox 492, parameter checkbox 493 and output checkbox 404 checkbox associated with that given application variable 490, thereby designating the particular application variable available for use as input, parameters and/or as output when creating a new rule. Details of the application variables 490, such as variable name 495 and data type 496, can also be displayed in respective fields, as shown.

UI screen 900 also includes a save button 497 for saving changes made to variable configurations. A search field 498 is also included, allowing users to quickly locate specific variables within the list of available application variables 490.

Selecting the input variables tab 481 can display, via UI screen 900, those application variables from among the list of available application variables 490 that have been marked or selected as inputs 492 in the application variables tab 480. In this example, the variable named “deposit_dt” is the only variable designated as an input variable. As a result, selecting the input variables tab 481 displays the “deposit_dt” variable.

Selecting the output variables tab 482 can display, via UI screen 900, those application variables from among the list of available application variables 490 that have been marked or selected as outputs 494 in the application variables tab 480. In this example, the variable named “Orbo_Alert” is the only variable designated as an output variable. As a result, selecting the output variables tab 482 displays the “Orbo_Alert” variable.

Selecting the parameters tab 483 can display, via UI screen 900, those application variables from among the list of available application variables 490 that have been marked or selected as parameters 493 in the application variables tab 480. Variables marked or selected as parameters can be utilized to refine or influence a rule's behavior. In this example, none of the variables have been designated as parameters.

Users can also define constant variables by selecting the constants tab 484, which can be configured to reveal previously-created constant variables and/or data entry fields for creating new constant variables (not shown). For example, the data entry fields can prompt a user to provide a name for a new constant variable, a data type (e.g., integer, string, double, etc.) and, depending on the selected data type, an assigned specific value for the constant variable (e.g., numerical value for integers, text for strings, decimal value for doubles, etc.). The constant variable information can then be confirmed and created by the platform.

In some cases, the derived variables tab 485 can provide functionality for creating and managing derived variables. Derived variables can be user-defined variables that are based on existing or to-be-defined variables. The UI screen 900 can be configured to enable users to specify the logic and/or calculations used to derive these derived variables from other variables in the system 100. In some embodiments, selecting the derived variables tab 485 can reveal previously-created derived variables and/or data entry fields for creating new derived variables (not shown). For example, data entry fields included in the derived variables tab 485 can prompt a user to provide a name for a new derived variable, a data type (e.g., integer, string, double, etc.), and a default value according to the selected data type (e.g., numerical value for integers, text for strings, etc.). This tab 485 can also be configured to enable users to select a function and related value to complete the logic of the newly-created derived variable. In some embodiments, users can upload a list of derived variables (e.g., defined in a spreadsheet) that includes, for each derived variable, a name, data type, default value and/or other information relevant to each derived variable. Derived variable logic can incorporate various functions to assist in deriving variables. Some examples of such functions can include (without limitation) Max, Min, Sum, Sub, Avg, RoundDivision, Division, DaysDiff, MonthDiff, YearDiff, Mul, Length, SubInt, DivInt, SumInt, Concat, Substring, VarDate, Between, Equal, dateBefore, dateAfter, etc.

The real-time variables tab 486 can offer functionality for creating and managing real-time (velocity configurable) variables. These variables may be used to capture and analyze real-time data streams, thereby enabling the system to identify patterns or trends as they occur. In some embodiments, selecting the real-time variables tab 486 can reveal previously-created real-time variables and/or data entry fields for creating new real-time variables (not shown). Real-time variables represent variables that can create attributes on the fly and return real-time values as they occur. For example, a real-time variable can be defined to return a real-time count of the instances that an account was accessed within the last 30 minutes. Starting from the time of the request, the real-time variable can be configured to return a tally of the number of times said account was accessed during the last 30 minutes. As noted above, data entry fields can prompt a user to provide information for creating real-time variables, such as a name, function(s) (e.g., count, sum, total, etc.), data type (e.g., integer, string, double, etc.), value for each function, duration (e.g., 30 min, 30 days, etc.), threshold limits, etc. for each real-time variable.

Once all variables are uploaded, selected, defined, and/or configured within a ruleset, the variables can become accessible for use in defining rules and/or conditions within that ruleset. Defining rules and/or conditions can be activated by selecting the add new rule button 420 (e.g., as shown in FIGS. 5 and 8), which can cause a rule-create interface, such as UI screen 1000 (see FIG. 10), to be displayed.

FIG. 10 depicts UI screen 1000, which can be configured for making rules. This UI screen 100 can be displayed when a user selects the add new rule button 420. This UI screen 1000 can include fields for defining new rules within the rules engine system 100. As shown, the UI screen 1000 includes a rule identifier field 440, a rule description field 441, a rule form field 442, input fields 443 and output fields 444. In other embodiments, UI screen 1000 can include other fields for defining rules. In this example, the rule identifier field 440 and rule description field 441 can be configured to enable users to provide basic information of the rule being created, such as the rule's unique identifier and a description for the rule and/or the rule's purpose, respectively.

The rule form field 442 can be configured to enable users to select how they wish to define the rule being created (e.g., structured or freeform), and in some embodiments (as shown here), the rule form field 442 can be configured a dropdown menu that includes options for creating a rule using a structured approach or a freeform approach. The input fields 443 and output fields 444 can be configured to enable users to define the parameters, operators and/or values that will be used to define the rule's conditions.

Selecting the structured approach via the rule form field 442 can reveal a structured, user-friendly interface that prompts the user for all information needed to define the logic of a new rule. UI screen 1000 is an example of this structured, user-friendly interface. To that end, UI screen 1000 includes predefined dropdown menus or fields (e.g., the input fields 443 and output fields 444) to guide a user through selecting the input parameters (e.g., variables, operators and input values) that define a rule's conditions, as well as the output parameters (e.g., variables and values) that dictate the resulting actions or outputs based on the defined conditions. The variables utilized in defining input and/or output logic can include those variables made available for rule making via UI screen 900, discussed above. The operators that can be used in defining rule logic can include any number and type of operators such as, for example, greater than (>), less than (<), equal to (=), not equal, between, contains, not contains, in, not in, etc.

Alternatively, selecting the freeform approach via rule form field 442 can provide greater flexibility as it presents one or more open text boxes (not shown) for inputting variables, operators, and values for defining both input and output logic. This option permits users to define rule parameters in freeform text, providing more customization in defining rule creation and outcomes.

In some embodiments, rules can be created having multiple conditions defined by multiple sets of input logic (e.g., each defined by a respective combination of variables, operators, and values) and output logic (each defined by a respective combination of variables and values).

Control buttons included on UI screen 1000 can provide functionality for managing the rule creation process. As shown, this UI screen 1000 includes a validate button 445, a save button 446, and a cancel button 447. The validate button 445 can initiate a validation process to ensure that a newly-created rule is properly formed before it is saved. For example, this validation process can include a data-integrity routine for ensuring that entered data values comply with their designated data types. If any discrepancies or incapabilities are identified, they can be highlighted, and the user can be prompted to resolve the same.

After a rule is validated, the save button 446 can be activated to store the newly created rule in the system's database 114. If at any point during the rule creation and/or validation process a user wishes to stop creating the rule, the user can activate the cancel button 447. Activating the cancel button 447 enables the user to exit the rule creation process without saving changes.

Once a rule is created, validated, and saved, its details, such as its priority order, rule identifier, description, input expression, and output expression can be showcased in a row format with other rules in a ruleset, as shown in UI screen 500, for example. The details for each rule can be presented one after another, allowing easy visibility and reference to understand each rule's configuration. These created rules can be displayed as a list, as shown on UI screen 500, organized based on their respective priority. This layout enables users to view and manage multiple rules efficiently. When a rule is created, the input logic defined by variables, operators, and values can be incorporated into an input expression field (e.g., see input expression field 418 on UI screen 500). In some embodiments, if the input logic defines multiple sets of conditions, they can be represented together in the input expression field, separated by a predefined symbol such as ‘&&’ (not shown). This format ensures clarity, combining all relevant input parameters within each rule's conditions. Similarly, output logic can be formatted in a similar manner within the output expression field (e.g., see output expression field 419 on UI screen 500), providing a coherent representation of the rule's defined outcomes.

As noted above, the platform 110 described herein includes a UI engine 111 and a rules engine 112, which work together to enable user interaction with the system 100 through various user interface screens displayed via the display unit 124 of the user device 120. These interface screens, such as those illustrated in FIGS. 4-10, can facilitate the creation, modification, and management of rules and rulesets that can be consumed by software applications 131-133 without requiring redeployment of those applications 131-133, as discussed above.

When a user device 120 interacts with a rule engine interface screen (e.g., UI screen 400, UI screen 500, etc.), such as by selecting options from the domain selector 401, application selector 403, sub application selector 405, ruleset selector 407, and/or version selector 409, the UI engine 111 can communicate these selections to the rules engine 112. The rules engine 112 can in turn query the database 114 to retrieve and display the appropriate rules/ruleset 410 based on the user's selections.

For example, when a user selects a specific domain, application, sub-application, ruleset, and version using the selectors 401-409 shown on UI screen 500, for example, the UI engine 111 can be configured to send this information to the rules engine 112. The rules engine 112 can then retrieve the corresponding ruleset 410 from the database 114 and send it back to the UI engine 111 for display on UI screen 500 via the interactive UI 111a.

When a user activates the add new rule button 420, for example, via UI screen 800, the UI engine 111 can communicate this action to the rules engine 112. In response, the rules engine 112 can generate the necessary data structures for a new rule and instruct the UI engine 111 to display a UI screen (e.g., UI screen 1000) configured for creating a new rule. As the user inputs information into the rule identifier field 440 and rule description field 441, and defines the rule logic using the input fields 443 and output fields 444, the UI engine 111 can continuously update the rules engine 112 with this information.

Upon selecting the validate button 445, such as the one included on UI screen 1000, for example, the UI engine 111 can signal the rules engine 112 to perform a validation routine on the entered rule data. The rules engine 112 can then execute this validation, checking for syntax errors, logical consistency, and proper data types. If any issues are detected, the rules engine 112 can instruct the UI engine 111 to display appropriate error messages (and/or prompts) on the UI screen 1000 for resolving any such issues.

When the user activates the save button 446, the UI engine 111 can communicate this action to the rules engine 112. The rules engine 112 can then store the new or modified rule in the database 114. At this point, the rules engine 112 can also package the new rule and/or other rules in a ruleset for consumption by software applications 131-133. This packaging process can involve converting a set of rules into a format that is compatible for running in a particular runtime environment.

As described above, the rules engine 112 includes APIs 112a for enabling communications between applications, services, and resources. These APIs 112a can facilitate the transmission of packaged rules 131a, 132a, 133a to one or more third-party computing systems 130 that include software applications 131-133 configured to consume rules created via the rules engine 112. Notably, the rules engine 112 can be configured to make the packaged rules 131a, 132a, 133a available to these software applications 131-133 for consumption without requiring redeployment of the software applications 131-133.

When a user interacts with a UI screen (such as UI screen 900, for example), such as by selecting variables using the select all checkbox 491, input checkbox 492, parameter checkbox 493, and/or output checkbox 494, the UI engine 111 can communicate these selections to the rules engine 112. The rules engine 112 can then update its internal representation of available variables and their designated uses.

If a user activates the bulk upload button 450 (e.g., via UI screens 500, 600 and/or 800), the UI engine 111 can signal the rules engine 112 to prepare for a bulk upload operation. The rules engine 112 can then process an uploaded file, extracting rule and/or variable definitions and storing them in the database 114. Similarly, when a user activates the spreadsheet download button 430 (e.g., via UI screens 500, 600, and/or 800), the rules engine 112 can generate a comprehensive compilation of ruleset data and instruct the UI engine 111 to initiate a download of this data to the user device 120.

The live deployment button 424 and admin panel button 470 (e.g., see UI screens 500, 600 and/or 800) can trigger more complex interactions between the UI engine 111 and the rules engine 112. When activated, these buttons 424, 470 can initiate processes that involve multiple steps and potentially require administrator approval, as discussed above. The rules engine 112 can manage these processes, updating the UI engine 111 as necessary to reflect the current status of these operations.

In this way, the UI engine 111 and rules engine 112 work in concert to provide a seamless user experience for creating, modifying, and managing rules and rulesets, while also handling the underlying complexities of rule storage, validation, and deployment to software applications.

The rules engine structure described herein (e.g., the platform 110, rules engine 112, etc.) provides a comprehensive solution for managing decision-making logic across multiple software applications. By decoupling the decision-making logic from the software applications 131-133 themselves, the rules engine structure enables more efficient and flexible management of rules and strategies.

In operation, the rules engine structure may serve as a central hub for creating, modifying, and managing rules and strategies. Users may interact with the rules engine structure through a user interface 111a to define variables, create rules, and construct strategies. These rules and strategies may then be packaged and made available for consumption by various software applications 131-133 without requiring changes to the applications' core code.

The rules engine structure improves efficiency in several ways. For example, when a business rule needs to be updated, users may modify the rule through the platform's interface 111a. This modification may be immediately available to all connected software applications 131-133 without the need for redeployment or downtime. In some cases, this capability may significantly reduce the time and resources required to implement changes across multiple systems.

Flexibility may be enhanced through the platform's ability to support a wide range of rule types and decision-making scenarios. Users may create simple conditional rules or complex logical operations to address various business needs. In some cases, the rules engine structure allows for the creation of derived variables, enabling more sophisticated decision-making processes without increasing complexity for end-users.

The scalability of the rules engine structure may be demonstrated through its ability to handle growing data volumes and evolving use-case requirements. As businesses expand or new regulations emerge, additional rules and strategies may be added without compromising performance. In some cases, the rules engine structure may support distributed deployment, allowing for efficient rule execution across multiple servers or cloud environments.

The rules engine structure may also provide benefits in terms of consistency and reusability. By centralizing rule management, organizations may ensure that the same decision-making logic is applied consistently across all relevant applications. This centralization may reduce the risk of discrepancies and errors that could arise from maintaining separate rule sets for different systems.

In some cases, the rules engine structure may integrate with machine learning models for continuous learning and strategy improvement. This integration may allow the overall system to adapt and refine its decision-making processes based on real-world outcomes and changing patterns. For example, in a fraud detection scenario, the rules engine structure may continuously update its rules and strategies based on new fraud patterns identified by machine learning algorithms. This adaptive capability may enhance the structure's effectiveness over time without requiring constant manual intervention.

The ability of the rules engine structure to generate forward-collection velocity variables may provide additional benefits in certain scenarios. For instance, in financial services applications, these variables may be used to identify patterns of activity that could indicate fraud or other risks. This may be accomplished without requiring coding or compiling, thereby reducing the workload on development resources, and accelerating the implementation of new risk management strategies.

Overall, the rules engine structure provides a powerful tool for streamlining decision-making processes, improving operational efficiency, and maintaining agility in the face of changing business and operational requirements. By separating decision logic from application code, the rules engine structure described herein enables more rapid and flexible responses to evolving needs across a wide range of industries and use cases.

A computer-readable storage medium is also contemplated by the present disclosure. The computer-readable storage medium includes one or more sequences of computer-readable instructions that, when executed by one or more processors, cause a computer device, system and/or platform to perform any of the operations described herein, including those described as being performed by the electronic document management platform and integrated user interaction tool of the present disclosure and/or its related components, devices and/or systems.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some embodiments, computers may comprise processors, memories, data storage devices, and/or other components. These components may be connected physically or through network or wireless links. Computers may also comprise software which may direct the operations of the aforementioned components. Computers may be referred to as servers, personal computers (PCs), mobile devices, and other terms for computing/communication devices. For purposes of this disclosure, those terms used herein are interchangeable, and any special purpose computer particularly configured for performing the described functions may be used.

Computers may be linked to one another via one or more networks. A network may be any plurality of completely or partially interconnected computers wherein some or all of the computers are able to communicate with one another. Connections between computers may be wired in some cases (e.g., via wired TCP connection or other wired connection) or may be wireless (e.g., via a Wi-Fi network connection). Any connection through which at least two computers may exchange data can be the basis of a network. Furthermore, separate networks may be able to be interconnected such that one or more computers within one network may communicate with one or more computers in another network. In such a case, the plurality of separate networks may optionally be considered to be a single network.

The term “computer” shall refer to any electronic device or devices, including those having capabilities to be utilized in connection with an electronic information/transaction system, such as any device capable of receiving, transmitting, processing, and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with the systems and methods described herein, such as, for example, any public and/or private networks, including, for instance, the Internet, an intranet, or an extranet, any wired or wireless networks or combinations thereof.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

1. A computer system for decoupling decision-making logic from software applications, the computer system comprising one or more processors and one or more storage media storing instructions that, when executed by the one or more processors, cause the computer system to implement:
a platform including a rules engine and a user interface engine;
a rules database accessible by the rules engine;
one or more user devices that access the platform via a user interface generated by the user interface engine; and
one or more third-party computing systems including software applications that consume rules created by the rules engine,
the rules engine performing the following operations:
receive, via the user interface, input for creating or modifying rules,
store the created or modified rules in the rules database,
package the rules for consumption by the software applications,
convert the packaged rules into executable classes, and
deploy the executable classes to the same virtual machine as the software applications during runtime, the software applications invoking the executable classes through dynamic linking without requiring compilation or redeployment of the software applications.

2. The system of claim 1, wherein the rules engine further to:
receives, via the user interface, input for creating or modifying variables used in the rules;
stores the created or modified variables in the rules database; and
makes the variables available for use in creating or modifying rules.

3. The system of claim 2, wherein the variables include at least one of: input variables, output variables, parameters, constants, derived variables, or real-time variables.

4. The system of claim 1, wherein the user interface includes selectors for defining logical groupings of the rules, the selectors including at least one of: a domain selector, an application selector, a sub-application selector, a ruleset selector, or a version selector.

5. The system of claim 1, wherein the user interface includes controls for managing the rules, the controls including at least one of: an add new rule button, an add variable button, a live deployment button, a version save button, a ruleset test button, or a spreadsheet download button.

6. The system of claim 1, wherein the rules engine further:
validates syntax and variables of created or modified rules; and
displays validation results via the user interface.

7. The system of claim 1, wherein the rules engine further:
receives, via the user interface, input for creating or modifying strategies comprising multiple rules; and
stores the created or modified strategies in the rules database.

8. (canceled)

9. The system of claim 1, wherein the user interface includes functionality for bulk uploading of rules or variables via a spreadsheet file.

10. The system of claim 1, wherein the rules engine further:
generates forward-collection velocity variables for use in rules without requiring coding or compiling.

11. A computer-implemented method for decoupling decision-making logic from software applications, the method performed by one or more processors executing instructions stored on one or more storage media, the method comprising:
receiving, via a user interface, input for creating or modifying rules;
storing the created or modified rules in a rules database;
packaging the rules for consumption by software applications;
converting the packaged rules into executable classes; and
deploying the executable classes to the same virtual machine as the software applications during runtime, the software applications invoking the executable classes through dynamic linking without requiring compilation or redeployment of the software applications.

12. The method of claim 11, further comprising:
receiving, via the user interface, input for creating or modifying variables used in the rules;
storing the created or modified variables in the rules database; and
making the variables available for use in creating or modifying rules.

13. The method of claim 11, further comprising:
providing, via the user interface, selectors for defining logical groupings of rules, the selectors including at least one of: a domain selector, an application selector, a sub-application selector, a ruleset selector, or a version selector.

14. The method of claim 11, further comprising:
validating syntax and variables of created or modified rules; and
displaying validation results via the user interface.

15. The method of claim 11, further comprising:
receiving, via the user interface, input for creating or modifying strategies comprising multiple rules; and
storing the created or modified strategies in the rules database.

16. (canceled)

17. The method of claim 11, further comprising:
providing, via the user interface, functionality for bulk uploading of rules or variables via a spreadsheet file.

18. The method of claim 11, further comprising:
generating forward-collection velocity variables for use in rules without requiring coding or compiling.

19. A non-transitory computer-readable medium storing instructions that, when executed by one or more processors, cause the one or more processors to perform operations comprising:
receiving, via a user interface, input for creating or modifying rules;
storing the created or modified rules in a rules database;
packaging the rules for consumption by software applications;
converting the packaged rules into executable classes; and
deploying the executable classes to the same virtual machine as the software applications during runtime, the software applications invoking the executable classes through dynamic linking without requiring compilation or redeployment of the software applications.

20. The non-transitory computer-readable medium of claim 19, wherein the operations further comprise:
receiving, via the user interface, input for creating or modifying variables used in the rules;
storing the created or modified variables in the rules database;
making the variables available for use in creating or modifying rules;
validating syntax and variables of created or modified rules; and
displaying validation results via the user interface.

21. The non-transitory computer-readable medium of claim 19, wherein the operations further comprise:
providing, via the user interface, selectors for defining logical groupings of the rules, the selectors including at least one of: a domain selector, an application selector, a sub-application selector, a ruleset selector, or a version selector.

22. The non-transitory computer-readable medium of claim 19, wherein the operations further comprise:
providing, via the user interface, controls for managing the rules, the controls including at least one of: an add new rule button, an add variable button, a live deployment button, a version save button, a ruleset test button, or a spreadsheet download button.

23. The non-transitory computer-readable medium of claim 19, wherein the operations further comprise:
receiving, via the user interface, input for creating or modifying strategies comprising multiple rules; and
storing the created or modified strategies in the rules database.

24. The non-transitory computer-readable medium of claim 19, wherein the operations further comprise:
providing, via the user interface, functionality for bulk uploading of rules or variables via a spreadsheet file.

25. The non-transitory computer-readable medium of claim 19, wherein the operations further comprise:
generating forward-collection velocity variables for use in rules without requiring coding or compiling.
